(19) United States
(12) Patent Application Publication
(10) Pub. No.: US 2021/0247196 A1
(43) Pub. Date: Aug. 12, 2021

(54) Object Detection for Light Electric Vehicles

(71) Applicant: Uber Technologies, Inc., San Francisco, CA (US)

(72) Inventors: Alan Hugh Wells, San Rafael, CA (US); Lucie Zikova, San Francisco, CA (US); Himaanshu Gupta, Millbrae, CA (US); Aaron Rogan, Boulder, CO (US); Mark Calleija, San Francisco, CA (US)

(21) Appl. No.: 17/172,357

(22) Filed: Feb. 10, 2021

Related U.S. Application Data
(60) Provisional application No. 63/018,860, filed on May 1, 2020.
(60) Provisional application No. 62/972,158, filed on Feb. 10, 2020.

(51) Int. Cl. G01C 21/34; G06Q 50/30; G06Q 10/02

(52) U.S. Cl. CPC G01C 21/3438; G06Q 10/02; G06Q 50/30

(57) ABSTRACT

Systems and methods for detecting objects with autonomous light electric vehicles are provided. A computer-implemented method can include obtaining, by a computing system comprising one or more computing devices positioned onboard an autonomous light electric vehicle, image data from a camera located onboard the autonomous light electric vehicle. The computer-implemented method can further include determining, by the computing system, that the autonomous light electric vehicle has a likelihood of interacting with an object based at least in part on the image data. In response to determining that the autonomous light electric vehicle has the likelihood of interacting with the object, the computer-implemented method can further include determining, by the computing system, a control action to modify an operation of the autonomous light electric vehicle. The computer-implemented method can further include implementing, by the computing system, the control action.

### PRIORITY CLAIM

The present application claims filing benefit of U.S. Provisional Patent Application Ser. No. 62/972,158 having a filing date of Feb. 10, 2020 and U.S. Provisional Patent Application Ser. No. 63/018,860 having a filing date of May 1, 2020, which are incorporated herein by reference in their entirety.

### FIELD

The present disclosure relates generally to devices, systems, and methods for object detection and autonomous navigation using sensor data from an autonomous light electric vehicle.

### BACKGROUND

Light electric vehicles (LEVs) can include passenger carrying vehicles that are powered by a battery, fuel cell, and/or hybrid-powered. LEVs can include, for example, bikes and scooters. Entities can make LEVs available for use by individuals. For instance, an entity can allow an individual to rent/lease a LEV upon request on an on-demand type basis. The individual can pick-up the LEV at one location, utilize it for transportation, and leave the LEV at another location so that the entity can make the LEV available for use by other individuals.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for controlling an autonomous light electric vehicle. The computer-implemented method can include obtaining, by a computing system comprising one or more computing devices positioned onboard an autonomous light electric vehicle, image data from a camera located onboard the autonomous light electric vehicle. The computer-implemented method can further include determining, by the computing system, that the autonomous light electric vehicle has a likelihood of interacting with an object based at least in part on the image data. In response to determining that the autonomous light electric vehicle has the likelihood of interacting with the object, the computer-implemented method can further include determining, by the computing system, a control action to modify an operation of the autonomous light electric vehicle. The computer-implemented method can further include implementing, by the computing system, the control action.

Another example aspect of the present disclosure is directed to a computing system. The computing system can include one or more processors and one or more tangible, non-transitory, computer readable media that store instructions that when executed by the one or more processors cause the computing system to perform operations. The operations can include obtaining data indicative of an object density from a plurality of autonomous light electric vehicles within a geographic area. The operations can further include determining an aggregated object density for the geographic area based at least in part on the data indicative of the object density obtained from the plurality of autonomous light electric vehicles. The operations can further include controlling an operation of at least one autonomous light electric vehicle within the geographic area based at least in part on the aggregated object density for the geographic area.

Another example aspect of the present disclosure is directed to an autonomous light electric vehicle. The autonomous light electric vehicle can include a camera, one or more pressure sensors, torque sensors, or force sensors. The autonomous light electric vehicle can further include one or more one or more processors, and one or more tangible, non-transitory, computer readable media that store instructions that when executed by the one or more processors cause the computing system to perform operations. The operations can include obtaining image data from the camera. The operations can further include obtaining sensor data from the one or more pressure sensors, torque sensors, or force sensors. The operations can further include determining that the autonomous light electric vehicle has a likelihood of interacting with an object based at least in part on the image data. The operations can further include determining a weight distribution of a payload onboard the autonomous light electric vehicle based at least in part on the sensor data. In response to determining that the autonomous light electric vehicle has the likelihood of interacting with an object, the operations can further include determining a deceleration rate or acceleration rate for the autonomous light electric vehicle based at least in part the weight distribution of the payload. The operations can further include decelerating or accelerating the autonomous light electric vehicle according to the deceleration rate or the deceleration rate.

Other aspects of the present disclosure are directed to various computing systems, vehicles, apparatuses, tangible, non-transitory, computer-readable media, and computing devices.

The technology described herein can help improve the safety of passengers of an autonomous LEV, improve the safety of the surroundings of the autonomous LEV, improve the experience of the rider and/or operator of the autonomous LEV, as well as provide other improvements as described herein. Moreover, the autonomous LEV technology of the present disclosure can help improve the ability of an autonomous LEV to effectively provide vehicle services to others and support the various members of the community in which the autonomous LEV is operating, including persons with reduced mobility and/or persons that are underserved by other transportation options. Additionally, the autonomous LEV of the present disclosure may reduce traffic congestion in communities as well as provide alternate forms of transportation that may provide environmental benefits.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example autonomous light electric vehicle computing system according to example aspects of the present disclosure;

FIG. 2 depicts an example autonomous light electric vehicle according to example aspects of the present disclosure;

FIG. 3A depicts an example image of a walkway and street according to example aspects of the present disclosure;

FIG. 3B depicts an example image segmentation of the example image of the walkway and street according to example aspects of the present disclosure;

FIG. 4 depicts an example walkway and walkway sections according to example aspects of the present disclosure;

FIG. 5 depicts an example object detection and interaction analysis according to example aspects of the present disclosure;

FIG. 6 depicts an example navigation path analysis for an autonomous light electric vehicle according to example aspects of the present disclosure;

FIG. 7 depicts an example method according to example aspects of the present disclosure;

FIG. 8 depicts an example method according to example aspects of the present disclosure; and

FIG. 9 depicts example system components according to example aspects of the present disclosure.

### DETAILED DESCRIPTION

Example aspects of the present disclosure are directed to systems and methods for detecting objects, such as pedestrians, and controlling autonomous light electric vehicles (LEVs) using data from sensors located onboard the autonomous LEVs. For example, an autonomous LEV can be an electric-powered bicycle, scooter, or other light vehicle, and can be configured to operate in a variety of operating modes, such as a manual mode in which a human operator controls operation, a semi-autonomous mode in which a human operator provides some operational input, or a fully autonomous mode in which the autonomous LEV can drive, navigate, operate, etc. without human operator input.

LEVs have increased in popularity in part due to their ability to help reduce congestion, decrease emissions, and provide convenient, quick, and affordable transportation options, particularly within densely populated urban areas. For example, in some implementations, a rider can rent a LEV to travel a relatively short distance, such as several blocks in a downtown area. However, in some operating environments, a rider of an autonomous LEV may operate the autonomous LEV in an area populated with pedestrians and/or other objects. For example, due to the unavailability of suitable autonomous LEV infrastructure, such as a designated travel way, a rider of an autonomous LEV may operate the autonomous LEV in an area populated with pedestrians, such as a sidewalk or other pedestrian walkway. In a typical implementation, the rider of the autonomous LEV may manually control the steering and/or travel speed of the autonomous LEV. Thus, due to various factors, such as operating conditions, rider experience, pedestrian density, pedestrian behavior, etc., in some situations, there may exist a potential for the rider of an autonomous LEV to interact with an object in its surrounding environment. An interaction with an object can include, for example, the autonomous LEV potentially altering/impeding the path and/or motion of the object and/or potentially contacting the object (if unavoidable).

The systems and methods of the present disclosure, however, can allow for an autonomous LEV to determine that a likelihood of object interaction exists, and in response, determine a control action to modify the operation of the autonomous LEV. For example, to assist with autonomous operation, an autonomous LEV can include various sensors. Such sensors can include accelerometers (e.g., inertial measurement units (IMUs)), cameras (e.g., fisheye cameras, infrared cameras, 360 degree cameras, etc.), radio beacon sensors (e.g., Bluetooth low energy sensors), GPS sensors (e.g., GPS receivers/transmitters), ultrasonic sensors, pressure sensors, torque sensors or force sensors (load cells, strain gauges, etc.), Time of Flight (ToF) sensors, and/or other sensors configured to obtain data indicative of an environment in which the autonomous LEV is operating.

According to example aspects of the present disclosure, a computing system onboard the autonomous LEV can obtain image data from a camera of the autonomous LEV. In some implementations, the camera can be a 360 degree camera which can obtain image data of the surrounding environment around the entire autonomous LEV.

The computing system can determine that the autonomous LEV has a likelihood of interacting with an object based at least in part on the image data. For example, in some implementations, the computing system can select a subset of a field of view of the image data, such as a subset of the field of view corresponding to an area in front of the autonomous LEV in the direction the autonomous LEV is travelling.

In some implementations, the computing system can analyze the image data using a machine-learned model. For example, the machine-learned model can include an object classifier machine-learned model configured to detect a particular type of object (e.g., pedestrians, other LEVs, etc.) in the surrounding environment of the autonomous LEV.

In some implementations, the computing system can classify a type of object. For example, in various implementations, the machine-learned model can classify various types of pedestrians, such as adults, children, walking pedestrians, running pedestrians, pedestrians in wheelchairs, pedestrians using personal mobility devices, pedestrians on skateboards, and/or other types of pedestrians.

In some implementations, the computing system can determine that the autonomous LEV has a likelihood of interacting with an object by predicting a future motion of the object. For example, in some implementations, the computing system track an object (e.g., a pedestrian) over multiple frames of image data, determine a heading and velocity of the object, and can predict a future motion for the object by extrapolating the current velocity and heading of the object to a future time.

In some implementations, the computing system can predict a future motion of an object (e.g., a pedestrian) based at least in part on the type of object. For example, certain types of pedestrians, such as running pedestrians, may move faster than other types of pedestrians, such as walking pedestrians. In some implementations, the computing system can predict a future motion of the pedestrian based at least in part on additional data, such as map data or other classified object data. For example, map data can include information about the location of crosswalks, and the computing system can determine that a pedestrian approaching an intersection is likely to cross the intersection at the crosswalk.

In some implementations, the computing system can determine that the autonomous LEV has a likelihood of interacting with the object by, for example, using a vector-based analysis. For example, the current heading and velocity of the autonomous LEV can be compared to a predicted future motion of a pedestrian to see if the autonomous LEV and the pedestrian are expected to occupy the same location at the same time or if the motion of the autonomous LEV would prevent the pedestrian from doing so. If so, the computing system can determine that there is a likelihood of interacting with the object.

In response to determining that there is a likelihood of interacting with the object, the computing system can determine a control action to modify an operation of the autonomous LEV. For example, in some implementations, the control action can include limiting a maximum speed of the autonomous LEV, decelerating the autonomous LEV, bringing the autonomous LEV to a stop, providing an audible alert to the rider of the autonomous LEV, providing a haptic response to the rider of the autonomous LEV, sending an alert to a computing device associated with a rider of the autonomous LEV, and/or other control action. For example, the computing system can decelerate the autonomous LEV to a slower velocity to allow for the pedestrian's predicted future motion to move the pedestrian out of an expected path of the autonomous LEV.

In some implementations, the control action can further be determined based at least in part on an estimated distance to the object. For example, the computing system may decelerate the autonomous LEV more aggressively when a pedestrian is closer than when a pedestrian is further away.

In some situations, modifying the operation of the autonomous LEV can present a unique challenge due to several factors, such as a weight distribution of a payload or an experience level of a rider of the autonomous LEV. For example, unlike in an automobile in which a passenger is seated and secured to the vehicle with a safety belt, a rider of an LEV typically stands on a riding platform and steers using a handlebar. Thus, decelerating too quickly could cause the rider's center of gravity to shift unexpectedly, and cause the rider to lose control of the LEV and/or fall off the LEV. According to example aspects of the present disclosure, in some implementations, the computing system of the autonomous LEV can determine a weight distribution of a payload onboard the autonomous LEV. The payload can include, for example the rider and any items the rider is transporting. Further, the computing system can determine the control action to modify the operation of the autonomous LEV based at least in part on the weight distribution of the payload.

For example, in some implementations, the computing system of the autonomous LEV can obtain sensor data from one or more sensors onboard the autonomous LEV. For example, one or more pressure sensors, torque sensors or force sensors (load cells, strain gauges, etc.), rolling resistance sensors, cameras, and/or other sensors can provide sensor data which can then be used to determine a weight distribution of the payload onboard the autonomous LEV. For example, pressure sensors mounted under a riding platform can be used to determine the weight distribution of the payload. Further, the control action, such as a deceleration rate, can be determined based at least in part on the weight distribution, such as to prevent a rider from losing his or her balance.

In some implementations, the computing system can determine a control action to modify an operation of the autonomous LEV based at least in part on a rider profile associated with the rider. For example, the rider profile can include a rider proficiency metric determined based at least in part on previous autonomous LEV operating sessions for the rider. For example, operating an autonomous LEV safely, such as by avoiding pedestrians and/or abiding by traffic signals, can positively impact a rider proficiency metric, while operating the autonomous LEV unsafely can negatively impact the rider proficiency metric. In some implementations, the rider proficiency metric can be used to determine whether to allow a particular rider to operate the autonomous LEV in a pedestrian dense area.

According to additional aspects of the present disclosure, in some implementations, a computing system can obtain data indicative of an object density from a plurality of autonomous LEVs within a geographic area. For example, a remote computing system can be configured to communicate with a plurality of autonomous LEVs (e.g., a fleet), and can obtain data indicative of a pedestrian density within a geographic area in which the plurality of autonomous LEVs are operating, such as a downtown area of a city. For example, each autonomous LEV can communicate a number of pedestrians detected by the autonomous LEV in a particular location. Further, the remote computing system can aggregate the object density data to determine an aggregated object density for the geographic area, such as an aggregated pedestrian density.

The remote computing system can then control the operation of one or more autonomous LEVs within the geographic area based at least in part on the aggregated object density. For example, a rider of an autonomous LEV may request navigational instructions to a particular destination. The remote computing system can determine the navigational instructions to the particular destination to avoid areas with the highest object density, such as high pedestrian density.

In some implementations, the remote computing system can further determine the navigational instructions based at least in part on a route score. For example, the route score can be determined based on an availability of autonomous LEV infrastructure along the route. For example, routes that make use of designated travel ways, such as bike lanes, can be scored higher than routes in which the autonomous LEV travels on pedestrian walkways, such as sidewalks.

In some implementations, the navigational instructions can be provided to the rider by a user interface of the autonomous LEV. For example, an audio speaker can provide verbal instructions or a handlebar can provide haptic feedback, such as a vibration on a left handlebar to indicate a left turn. In some implementations, the navigational instructions can be provided to a user computing device associated with rider, such as a rider's smart phone.

In some implementations, the remote computing system can control the operation of one or more autonomous LEVs within the geographic area based at least in part on the aggregated object density by, for example, limiting the maximum speed of an autonomous LEV, limiting an area of a travel way in which the autonomous LEV can operate, and/or prohibiting the autonomous LEV from operating a particular area.

The systems and methods of the present disclosure can provide any number of technical effects and benefits. For example, by detecting objects, such as pedestrians, and controlling the operation of an autonomous LEV to avoid object interference, the safety of autonomous LEV operation can be increased for both surrounding objects and riders. Further, by aggregating object density data from a plurality of autonomous LEVs, intelligent autonomous LEV navigation and operation can be implemented to further improve the safety of autonomous LEV operation.

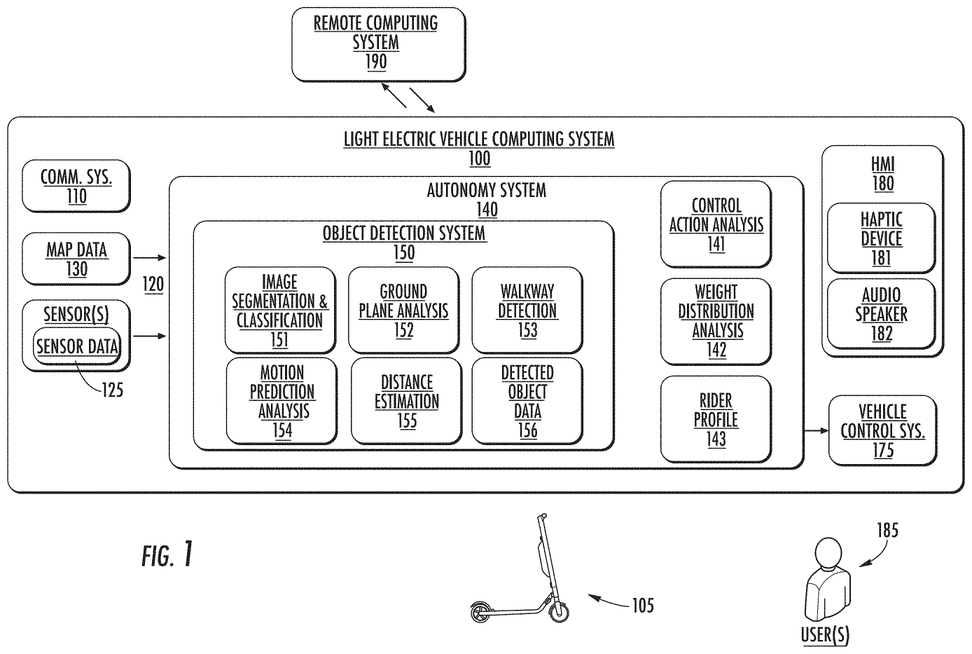

With reference now to the FIGS., example aspects of the present disclosure will be discussed in further detail. FIG. 1 illustrates an example LEV computing system 100 according to example aspects of the present disclosure. The LEV computing system 100 can be associated with an autonomous LEV 105. The LEV computing system 100 can be located onboard (e.g., included on and/or within) the autonomous LEV 105.

The autonomous LEV 105 incorporating the LEV computing system 100 can be various types of vehicles. For instance, the autonomous LEV 105 can be a ground-based autonomous LEV such as an electric bicycle, an electric scooter, an electric personal mobility vehicle, etc. The autonomous LEV 105 can travel, navigate, operate, etc. with minimal and/or no interaction from a human operator (e.g., rider/driver). In some implementations, a human operator can be omitted from the autonomous LEV 105 (and/or also omitted from remote control of the autonomous LEV 105). In some implementations, a human operator can be included in and/or associated with the autonomous LEV 105, such as a rider and/or a remote teleoperator.

In some implementations, the autonomous LEV 105 can be configured to operate in a plurality of operating modes. The autonomous LEV 105 can be configured to operate in a fully autonomous (e.g., self-driving) operating mode in which the autonomous LEV 105 is controllable without user input (e.g., can travel and navigate with no input from a human operator present in the autonomous LEV 105 and/or remote from the autonomous LEV 105). The autonomous LEV 105 can operate in a semi-autonomous operating mode in which the autonomous LEV 105 can operate with some input from a human operator present in the autonomous LEV 105 (and/or a human teleoperator that is remote from the autonomous LEV 105). The autonomous LEV 105 can enter into a manual operating mode in which the autonomous LEV 105 is fully controllable by a human operator (e.g., human rider, driver, etc.) and can be prohibited and/or disabled (e.g., temporary, permanently, etc.) from performing autonomous navigation (e.g., autonomous driving). In some implementations, the autonomous LEV 105 can implement vehicle operating assistance technology (e.g., collision mitigation system, power assist steering, etc.) while in the manual operating mode to help assist the human operator of the autonomous LEV 105.

The operating modes of the autonomous LEV 105 can be stored in a memory onboard the autonomous LEV 105. For example, the operating modes can be defined by an operating mode data structure (e.g., rule, list, table, etc.) that indicates one or more operating parameters for the autonomous LEV 105, while in the particular operating mode. For example, an operating mode data structure can indicate that the autonomous LEV 105 is to autonomously plan its motion when in the fully autonomous operating mode. The LEV computing system 100 can access the memory when implementing an operating mode.

The operating mode of the autonomous LEV 105 can be adjusted in a variety of manners. For example, the operating mode of the autonomous LEV 105 can be selected remotely, off-board the autonomous LEV 105. For example, a remote computing system 190 (e.g., of a vehicle provider and/or service entity associated with the autonomous LEV 105) can communicate data to the autonomous LEV 105 instructing the autonomous LEV 105 to enter into, exit from, maintain, etc. an operating mode. By way of example, such data can instruct the autonomous LEV 105 to enter into the fully autonomous operating mode. In some implementations, the operating mode of the autonomous LEV 105 can be set onboard and/or near the autonomous LEV 105. For example, the LEV computing system 100 can automatically determine when and where the autonomous LEV 105 is to enter, change, maintain, etc. a particular operating mode (e.g., without user input). Additionally, or alternatively, the operating mode of the autonomous LEV 105 can be manually selected via one or more interfaces located onboard the autonomous LEV 105 (e.g., key switch, button, etc.) and/or associated with a computing device proximate to the autonomous LEV 105 (e.g., a tablet operated by authorized personnel located near the autonomous LEV 105). In some implementations, the operating mode of the autonomous LEV 105 can be adjusted by manipulating a series of interfaces in a particular order to cause the autonomous LEV 105 to enter into a particular operating mode. In some implementations, the operating mode of the autonomous LEV 105 can be selected via a user's computing device (not shown), such as when a user 185 uses an application operating on the user computing device (not shown) to access or obtain permission to operate an autonomous LEV 105, such as for a short-term rental of the autonomous LEV 105. In some implementations, a fully autonomous mode can be disabled when a human operator is present.

In some implementations, the remote computing system 190 can communicate indirectly with the autonomous LEV 105. For example, the remote computing system 190 can obtain and/or communicate data to and/or from a third party computing system, which can then obtain/communicate data to and/or from the autonomous LEV 105. The third party computing system can be, for example, the computing system of an entity that manages, owns, operates, etc. one or more autonomous LEVs. The third party can make their autonomous LEV(s) available on a network associated with the remote computing system 190 (e.g., via a platform) so that the autonomous vehicles LEV(s) can be made available to user(s) 185.

The LEV computing system 100 can include one or more computing devices located onboard the autonomous LEV 105. For example, the computing device(s) can be located on and/or within the autonomous LEV 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the autonomous LEV 105 (e.g., its computing system, one or more processors, etc.) to perform operations and functions, such as those described herein for controlling an autonomous LEV 105, etc.

The autonomous LEV 105 can include a communications system 110 configured to allow the LEV computing system 100 (and its computing device(s)) to communicate with other computing devices. The LEV computing system 100 can use the communications system 110 to communicate with one or more computing device(s) that are remote from the autonomous LEV 105 over one or more networks (e.g., via one or more wireless signal connections). For example, the communications system 110 can allow the autonomous LEV to communicate and receive data from a remote computing system 190 of a service entity (e.g., an autonomous LEV rental entity), a third party computing system, a computing system of another autonomous LEV (e.g., a computing system onboard the other autonomous LEV), and/or a user computing device (e.g., a user's smart phone). In some implementations, the communications system 110 can allow communication among one or more of the system(s) on-board the autonomous LEV 105. The communications system 110 can include any suitable components for interfacing with one or more network(s), including, for example, transmitters, receivers, ports, controllers, antennas, and/or other suitable components that can help facilitate communication.

As shown in FIG. 1, the autonomous LEV 105 can include one or more vehicle sensors 120, an autonomy system 140, an object detection system 150 (e.g., a component of an autonomy system 140 or a stand-alone object detection system 150), one or more vehicle control systems 175, a human machine interface 180, a haptic device 181, an audio speaker 182, and/or other systems, as described herein. One or more of these systems can be configured to communicate with one another via a communication channel. The communication channel can include one or more data buses (e.g., controller area network (CAN)), on-board diagnostics connector (e.g., OBD-II), Ethernet, and/or a combination of wired and/or wireless communication links. The onboard systems can send and/or receive data, messages, signals, etc. amongst one another via the communication channel.

The vehicle sensor(s) 120 can be configured to acquire sensor data 125. The vehicle sensor(s) 120 can include a Light Detection and Ranging (LIDAR) system, a Radio Detection and Ranging (RADAR) system, one or more cameras (e.g., fisheye cameras, visible spectrum cameras, 360 degree cameras, infrared cameras, etc.), magnetometers, ultrasonic sensors, wheel encoders (e.g., wheel odometry sensors), steering angle encoders, positioning sensors (e.g., GPS sensors), inertial measurement sensors (e.g., accelerometers), pressure sensors, torque sensors or force sensors (load cells, strain gauges, etc.), rolling resistance sensors, radio beacon sensors (e.g., Bluetooth low energy sensors), radio sensors (e.g., cellular, WiFi, V2x, etc. sensors), Time of Flight (ToF) sensors, motion sensors, and/or other types of imaging capture devices and/or sensors. The sensor data 125 can include inertial measurement unit/accelerometer data, image data (e.g., camera data), RADAR data, LIDAR data, ultrasonic sensor data, radio beacon sensor data, GPS sensor data, pressure sensor data, torque or force sensor data, rolling resistance sensor data, and/or other data acquired by the vehicle sensor(s) 120. This can include sensor data 125 associated with the surrounding environment of the autonomous LEV 105. For example, a 360 degree camera can be configured to obtain image data in a 360 field of view around the autonomous LEV 105, which can include a rider positioned on the autonomous LEV 105. The sensor data 125 can also include sensor data 125 associated with the autonomous LEV 105. For example, the autonomous LEV 105 can include inertial measurement unit(s) (e.g., gyroscopes and/or accelerometers), wheel encoders, steering angle encoders, and/or other sensors.

In some implementations, an image from a 360 degree camera can be used to detect a kinematic configuration of the autonomous LEV 105. As an example, the image data can be input into a modeling/localization machine-learned model to detect the orientation of an autonomous LEV 105 in a surrounding environment. For example, image data can be used to detect whether a rotating base of an autonomous LEV 105 is protruding into a sidewalk. In some implementations, one or more identifiers can be positioned on known locations of the autonomous LEV 105 to aid in determining the kinematic configuration of the autonomous LEV 105.

In addition to the sensor data 125, the LEV computing system 100 can retrieve or otherwise obtain map data 130. The map data 130 can provide information about the surrounding environment of the autonomous LEV 105. In some implementations, an autonomous LEV 105 can obtain detailed map data that provides information regarding: the identity and location of different walkways, walkway sections, and/or walkway properties (e.g., spacing between walkway cracks); the identity and location of different radio beacons (e.g., Bluetooth low energy beacons); the identity and location of different position identifiers (e.g., QR codes visibly positioned in a geographic area); the identity and location of different LEV designated parking locations; the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, potholes, etc.); data indicative of events (e.g., scheduled concerts, parades, etc.); the location of collection points (e.g., LEV fleet pickup/dropoff locations); the location of charging stations; a rider location (e.g., the location of a rider requesting an autonomous LEV 105); one or more supply positioning locations (e.g., locations for the autonomous LEV 105 to be located when not in use in anticipation of demand); and/or any other map data that provides information that assists the autonomous LEV 105 in comprehending and perceiving its surrounding environment and its relationship thereto. In some implementations, the LEV computing system 100 can determine a vehicle route for the autonomous LEV 105 based at least in part on the map data 130.

In some implementations, the map data 130 can include an image map, such as an image map generated based at least in part on a plurality of images of a geographic area. For example, in some implementations, an image map can be generated from a plurality of aerial images of a geographic area. For example, the plurality of aerial images can be obtained from above the geographic area by, for example, an air-based camera (e.g., affixed to an airplane, helicopter, drone, etc.). In some implementations, the plurality of images of the geographic area can include a plurality of street view images obtained from a street-level perspective of the geographic area. For example, the plurality of street-view images can be obtained from a camera affixed to a ground-based vehicle, such as an automobile. In some implementations, the image map can be used by a visual localization model to determine a location of an autonomous LEV 105.

In some implementations, the object detection system 150 can obtain/receive the sensor data 125 from the vehicle sensor(s), and detect one or more objects (e.g., pedestrians, vehicles, etc.) in the surrounding environment of the autonomous LEV 105. Further, in some implementations, the object detection system 150 can determine that the autonomous LEV 105 has a likelihood of interacting with an object, and in response, determine a control action to modify an operation of the autonomous light electric vehicle. For example, the object detection system 150 can use image data to determine that the autonomous LEV 105 has a likelihood of interacting with an object, and in response, decelerate the autonomous LEV 105.

In some implementations, the object detection system 150 can detect one or more objects based at least in part on the sensor data 125 obtained from the vehicle sensor(s) 120 located onboard the autonomous LEV 105. In some implementations, the object detection system 150 can use various models, such as purpose-built heuristics, algorithms, machine-learned models, etc. to detect objects and control the autonomous LEV 105. The various models can include computer logic utilized to provide desired functionality. For example, in some implementations, the models can include program files stored on a storage device, loaded into a memory and executed by one or more processors. In other implementations, the models can include one or more sets of computer-executable instructions that are stored in a tangible computer-readable storage medium such as RAM hard disk, flash storage, or optical or magnetic media. In some implementations, the one or more models can include machine-learned models, such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

For example, in some implementations, the object detection system 150 can include an image segmentation and classification model 151. The image segmentation model 151 can segment or partition an image into a plurality of segments, such as, for example, a foreground, a background, a walkway, sections of a walkway, roadways, various objects (e.g., vehicles, pedestrians, trees, benches, tables, etc.), or other segments.

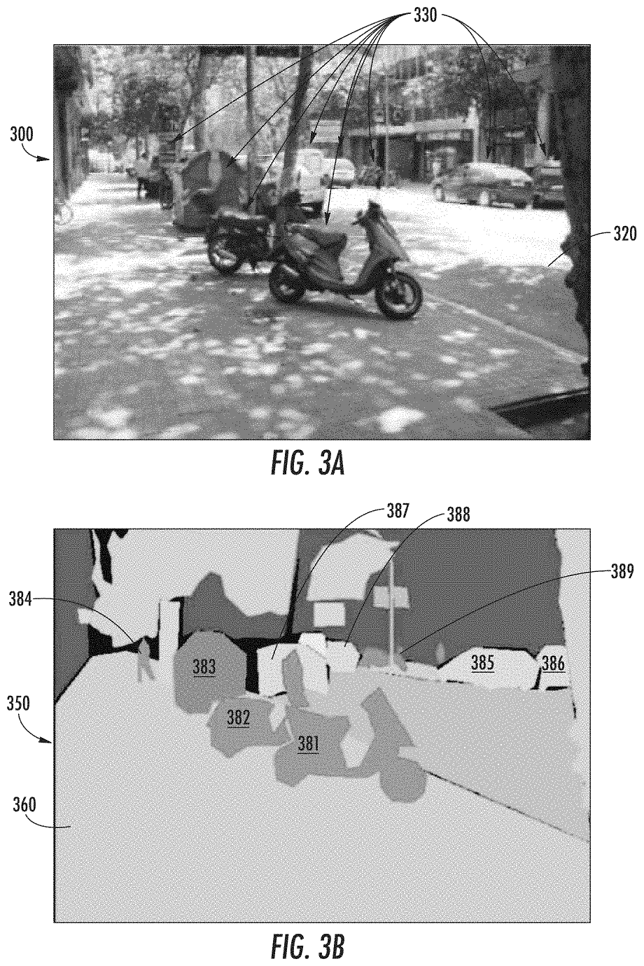

In some implementations, the image segmentation and classification model 151 can be trained using training data comprising a plurality of images labeled with various objects and aspects of each image. For example, a human reviewer can annotate a training dataset which can include a plurality of images with ground planes, walkways, sections of a walkway, roadways, various objects (e.g., vehicles, pedestrians, trees, benches, tables), etc. The human reviewer can segment and annotate each image in the training dataset with labels corresponding to each segment. For example, walkways and/or walkway sections (e.g., frontage zone, furniture zone, a pedestrian throughway, bicycle lane) in the images in the training dataset can be labeled, and the image segmentation and classification model 151 can be trained using any suitable machine-learned model training method (e.g., back propagation of errors). Once trained, the image segmentation and classification model 151 can receive an image, such as an image from a 360 degree camera located onboard an autonomous LEV 105, and can segment the image into corresponding segments. An example of an image segmented into objects, roads, and a walkway using an example image segmentation and classification model 151 is depicted in FIGS. 3A and 3B.

In some implementations, the image segmentation and classification model 151 can be configured to select a subset of a field of view of image data to analyze. For example, a field-of-view corresponding to an area in front of the autonomous LEV 105 can be selected. In this way, objects (e.g., pedestrians) in front of the autonomous LEV 105, and therefore in the direction of travel of the autonomous LEV 105, can be detected.

In some implementations, the image segmentation and classification model 151 can classify various types of objects. For example, in various implementations, the image segmentation and classification model 151 can classify types of pedestrians, such as adults, children, walking pedestrians, running pedestrians, pedestrians in wheelchairs, pedestrians using personal mobility devices, pedestrians on skateboards, and/or other types of pedestrians. By classifying different types of pedestrians, certain attributes can be determined for specific pedestrians, such as an expected travel speed or other behavior of the pedestrian. Similarly, certain attributes for other objects can likewise be determined, such as moving objects (e.g., vehicles, bicycles, etc.) and stationary objects (e.g. benches, trees, etc.). In some implementations, the image segmentation and classification model 151 can detect vehicles, such as cars, bicycles, other LEVs, etc. For example, the image segmentation and classification model 151 can detect objects traveling on a travelway, such as a road or LEV travelway.

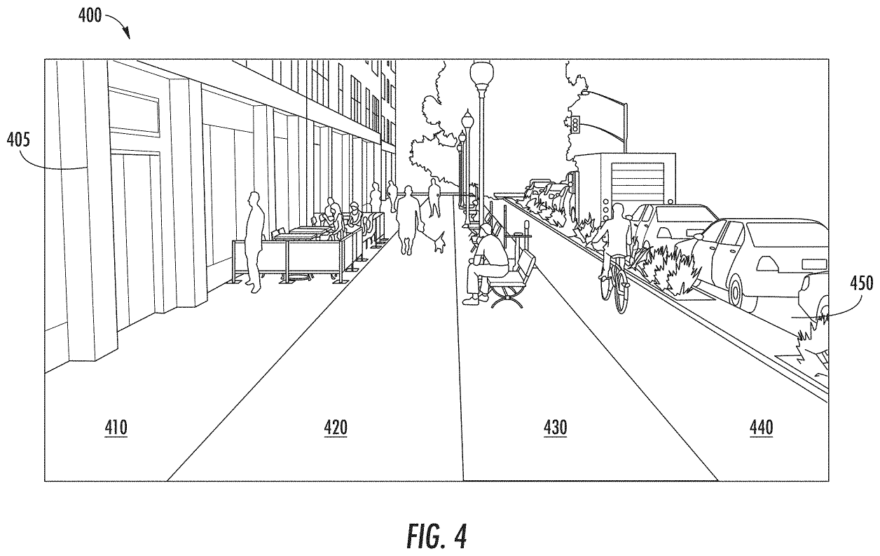

In some implementations, the object detection system 150 can include a ground plane analysis model 152. For example, an image can be segmented using an image segmentation and classification model 151, and a ground plane analysis model 152 can determine which segments of the image correspond to a ground plane (e.g., a navigable surface on which the autonomous LEV can travel). The ground plane analysis model 152 can be trained to detect a ground plane in an image, and further, to determine various properties of the ground plane, such as relative distances between objects positioned on the ground plane, which parts of a ground plane are navigable (e.g., can be travelled on), and other properties. In some implementations, the ground plane analysis model 152 can be included in or otherwise a part of an image segmentation and classification model 151. In some implementations, the ground plane analysis model 152 can be a stand-alone ground plane analysis model 152, such as a lightweight ground plane analysis model 152 configured to be used onboard the autonomous LEV 105. Example images with corresponding ground planes are depicted in FIGS. 3A, 3B, and 4.

In some implementations, the ground plane analysis model 152 and/or the image segmentation and classification model 151 can be used to localize an autonomous LEV 105. For example, a set of global features maps that have been labeled for a particular geographic area (e.g., a downtown portion of a city) can serve as an index to aid in refining an initial position for an autonomous LEV 105. Further, the search space can thus be reduced for more computing intensive precision localization.

In some implementations, the object detection system 150 can use walkway detection model 153 to determine that the autonomous LEV 105 is located on a walkway or to detect a walkway nearby. For example, the object detection system 150 can use accelerometer data and/or image data to detect a walkway. For example, as the autonomous LEV 105 travels on a walkway, the wheels of the autonomous LEV 105 will travel over cracks in the walkway, causing small vibrations to be recorded in the accelerometer data. The object detection system 150 can analyze the accelerometer data for a walkway signature waveform. For example, the walkway signature waveform can include periodic peaks repeated at relatively regular intervals, which can correspond to the acceleration caused by travelling over the cracks. In some implementations, the object detection system 150 can determine that the autonomous LEV 105 is located on a walkway by recognizing the walkway signature waveform. In some implementations, the walkway detection model 153 can use map data 130, such as map data 130 which can include walkway crack spacing data, to detect the walkway. In some implementations, the walkway detection model 153 can use speed data to detect the walkway, such as speed data obtained via GPS data, wheel encoder data, speedometer data, or other suitable data indicative of a speed.

In some implementations, the walkway detection model 153 can determine that the autonomous LEV 105 is located on or near a walkway based at least in part on one or more images obtained from a camera located onboard the autonomous LEV 105. For example, an image can be segmented using an image segmentation and classification model 151, and the walkway detection model 153 can be trained to detect a walkway or walkway sections. In some implementations, the walkway detection model 153 can be included in or otherwise a part of an image segmentation and classification model 151. In some implementations, the walkway detection model 153 can be a stand-alone walkway detection model 153, such as a lightweight walkway detection model 153 configured to be used onboard the autonomous LEV 105. An example image with a walkway segmented into a plurality of sections is depicted in FIG. 4.

In some implementations, the walkway detection model 153 can determine that the autonomous LEV is located on a walkway and/or a particular walkway section based on the orientation of the walkway and/or walkway sections in an image. For example, in some implementations, an image captured from a fisheye camera can include a perspective view of the autonomous LEV 105 located on the walkway or show the walkway on both a left side and a right side of the autonomous LEV 105, and therefore indicate that the autonomous LEV 105 is located on the walkway (and/or walkway section).

In some implementations, the walkway detection model 153 can be used to determine an authorized section of a travel way in which the autonomous LEV 105 is permitted to travel. For example, the walkway detection model 153 can analyze the ground plane to identify various sections of a travelway (e.g., a bicycle lane section of a sidewalk), and the navigation model 155 can determine one or more navigational instructions for the autonomous LEV 105 to travel in the authorized section of the travel way. For example, the one or more navigational instructions can include one or more navigational instructions for the autonomous LEV 105 to travel to the authorized travelway and, further, to travel along the authorized travelway.

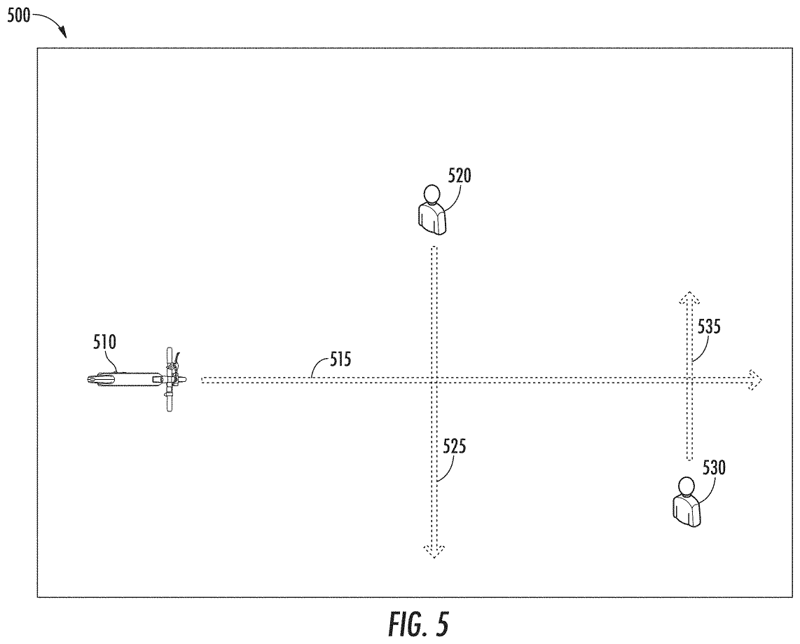

The object detection system 150 can also include a motion prediction analysis model 154. For example, the motion prediction analysis model 154 can be configured to predict a motion of an object, such as a pedestrian. For example, in some implementations, the motion prediction analysis model 154 can determine a predicted future motion for a pedestrian by extrapolating the current velocity of the pedestrian to determine a future position of the pedestrian at a future time. In some implementations, the motion prediction analysis model 154 can predict a motion of a pedestrian (or other object) based at least in part on a classification type of the pedestrian (or other object). For example, the motion prediction analysis model 154 can predict that a running pedestrian will travel further over a given period of time and a walking pedestrian. In some implementations, the motion prediction analysis model 154 can use additional data to determine a predicted future motion of an object. For example, map information, such as the location of crosswalks, can be used to predict that a pedestrian will cross an intersection at a crosswalk. Similarly, detected walkways and/or walkway sections obtained from the walkway detection model 153 can be used by the motion prediction analysis model 154, such as to determine a likely walkway and or walkway section on which an object (e.g., a pedestrian or vehicle) is likely to travel. An example motion prediction analysis is depicted in FIG. 5.

The object detection system 150 can also include a distance estimation model 155. For example, the motion distance estimation model 155 can be configured to estimate the distance from the autonomous LEV 105 to an object. For example, the distance estimation model 155 can use data generated by the object detection system 150, such as object type data from the image segmentation and classification model 151 and ground plane analysis data from the ground plane analysis model 152 to estimate the distance to a detected object. For example, the size of a classified pedestrian in an image as well as a position of the pedestrian on a ground plane can be used by the distance estimation model 155 to estimate the distance to the pedestrian. Further, a database of known objects, such as fire hydrants, road signs, or other similarly common objects in a geographic area can be used to provide improved distance estimation.

In this way, the models 151-155 of the object detection system 150 can work cooperatively to detect objects as well as determine information about the detected objects with respect to the surrounding environment of the autonomous LEV 105. For example, detected object data 156 determined by the object detection system 150 can include data regarding the position, size, classification, heading, velocity, and/or other information about one or more objects, as well as information about the objects, such as a predicted future motion of an object and/or an estimated distance to the object.

The vehicle autonomy system 140 can use the detected object data 156 determined by the object detection system 150 to determine one or more control actions for the autonomous LEV 105. For example, a control action analysis 141 can be performed by the autonomy system 140 to determine that the autonomous LEV 105 has a likelihood of interacting with an object based at least in part on the detected object data 156.

For example, as described in greater detail with respect to FIG. 5, the control action analysis 141 can analyze the detected object data 156 to determine if a predicted future motion of an object and a projected trajectory of the autonomous LEV 105 intersect at the same time. If so, the control action analysis 141 can determine that there is a likelihood of interacting with the object and/or interfering with the object, such as by blocking the object's path.

Additionally, in some implementations, the detected object data 156 can include, for example, parked vehicles, such as cars. As an example, the detected object data 156 can include a parked car which may have an open, opening, or likely to open door. The vehicle autonomy system 140 can detect the open/opening/likely to open door and use the detected object data 156 associated therewith to determine a control action to avoid an interaction with the open/opening/likely to open door.

For example, in response to determining that the autonomous LEV 105 has the likelihood of interacting with the object, the control action analysis 141 can determine a control action to modify an operation of the autonomous LEV 105. For example, in one implementation, the control action can include limiting a maximum speed of the autonomous LEV 105. For example, the control action analysis 141 can set a maximum speed threshold for the autonomous LEV 105 such that the autonomous LEV 105 cannot be manually controlled above the maximum speed threshold by the rider.

In some implementations, such as in response to detecting an open/opening/likely to open door, a control action can include alerting the rider or slowing down when near parked vehicles. In some implementations, a maximum speed can be limited based on a proximity to the one or more parked vehicles.

In some implementations, the control action can include decelerating the autonomous LEV 105. For example, a jerk-limited deceleration rate can be used to slow the velocity of autonomous LEV 105, such as below a maximum speed threshold. Similarly, a jerk-limited acceleration rate can be used to accelerate the autonomous LEV 105 to avoid an interaction with an object. In some implementations, the control action can include bringing the autonomous LEV 105 to a stop. For example, the autonomous LEV 105 can be decelerated until the autonomous LEV 105 comes to a complete stop.

In some implementations, the control action can include providing an audible alert to the rider of the autonomous LEV 105. For example, the autonomous LEV 105 can include an HMI (“Human Machine Interface”) 180 that can output data for and accept input from a user 185 of the autonomous LEV 105. The HMI 180 can include one or more output devices such as display devices, haptic devices 181, audio speakers 182, tactile devices, etc. In some implementations, the HMI 180 can provide an audible alert to a rider of an autonomous LEV 105 by providing the audible alert via an audio speaker 182.

Similarly, in some implementations, the control action can include providing a haptic response to the rider of the autonomous LEV 105. For example, one or more haptic devices 181 can be incorporated into a handlebar of the autonomous LEV 105, and a haptic response can be provided by, for example, vibrating the haptic device(s) 181 in the handlebar.

In some implementations, the control action can include sending an alert to a computing device associated with a rider of the autonomous LEV 105. For example, a push notification can be sent to the rider's smart phone.

In some implementations, the control action can further be determined based at least in part on an estimated distance to the object. For example, the autonomy system 140 may decelerate the autonomous LEV more aggressively when an object is closer than when an object is further away. In some implementations, various thresholds can be used to determine the control action by, for example, decelerating at a faster rate and/or bringing the autonomous LEV 105 to a stop.

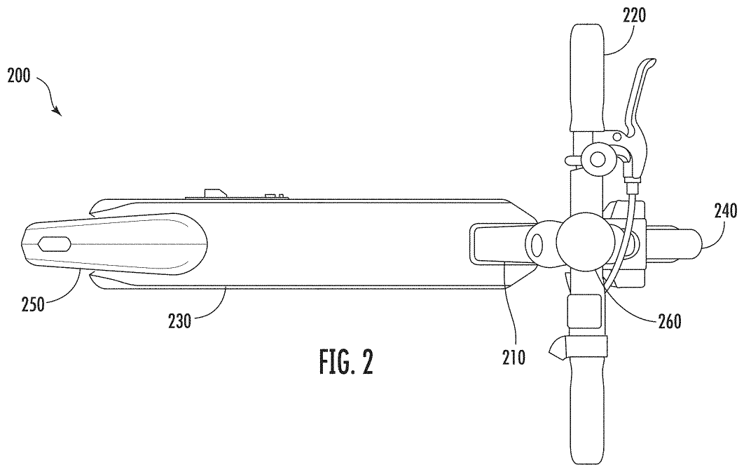

The autonomy system 140 can also include a weight distribution analysis model 142. The weight distribution analysis model 142 can be configured to determine a weight distribution of a payload onboard an autonomous LEV 105. For example, a rider and any items the rider is carrying can constitute a payload onboard the autonomous LEV 105. As will be described in greater detail with respect to FIG. 2, one or more sensors, such as pressure sensors, torque sensors or force sensors (load cells, strain gauges, etc.), rolling resistance sensors, etc. can be used to determine a weight distribution of the payload onboard the autonomous LEV 105. For example, a first pressure sensor can be positioned on a forward portion of a deck and a second pressure sensor can be positioned on a rear portion of the deck. Sensor data obtained from the two pressure sensors can be used to determine a weight distribution (e.g., a center of gravity) of the payload onboard the autonomous LEV 105. Similarly, a first rolling resistance sensor can be positioned on a forward wheel (e.g., a steering wheel), and a second rolling resistance sensor can be positioned on a rear wheel (e.g., a drive wheel), and sensor data obtained from the two sensors can be used to determine a weight distribution of the payload onboard the autonomous LEV 105.

In some implementations, the control action to modify the operation of the autonomous LEV can be determined based at least in part on the weight distribution of the payload. For example, as an autonomous LEV 105 is decelerated, the weight distribution of the payload onboard the autonomous LEV 105 may shift in response to the deceleration. In some implementations, the weight distribution of the payload can be monitored in real time in order to reduce the likelihood that the weight distribution shifts too far forward on the autonomous LEV 105, thereby causing the rider to lose control of the autonomous LEV 105 and/or fall off the autonomous LEV 105. In some implementations, the deceleration rate can be determined based at least in part on the weight distribution of the payload. For example, a more aggressive deceleration rate can be used when the weight distribution is further back on the autonomous LEV 105, whereas a less aggressive deceleration rate can be used when the weight distribution is further forward on the autonomous LEV 105.

Similarly, in some implementations, the control action to modify the operation of the autonomous LEV 105 can be to accelerate the autonomous LEV 105 to avoid an interaction with an object. For example, increasing a velocity can be used to avoid an interaction with an object (e.g., move out of the object's path of travel more quickly), cross a bumpy travelway (e.g., railroad tracks), or more smoothly maintain an optimal traffic flow. For example, as an autonomous LEV 105 is accelerated, the weight of the payload onboard the autonomous LEV 105 may shift in response to the acceleration. In some implementations, the weight distribution of the payload can be monitored in real time in order to reduce the likelihood that the weight distribution shifts too far backwards on the autonomous LV 105, thereby causing the rider to lose control of the autonomous LEV 105 and/or fall off the autonomous LEV 105. In some implementations, the acceleration rate can be determined based at least in part on the weight distribution of the payload. For example, a more aggressive acceleration rate can be used when the weight distribution is further forward on the autonomous LEV 105, whereas a less aggressive acceleration rate can be used when the weight distribution is further backwards on the autonomous LEV 105. Additionally, the braking force (when slowing down) and/or the drive force (when speeding up) distribution applied to the front and rear wheels of the autonomous LEV 105 can be modified according to the weight distribution of the payload.

In some implementations, the trajectory of the autonomous LEV 105 can be changed. For example, in an autonomous or unmanned mode, the autonomous LEV 105 may be repositioned periodically, such as to a LEV charging station or in an LEV designated parking location. In some implementations, a planned path of travel of the autonomous LEV 105 can be adjusted to avoid an interaction with an object, such as by steering to the left or right while travelling to the destination.

In some implementations, an autonomous LEV 105 can include one or more accelerometers configured to detect an interaction with an object. For example, one or more accelerometers can detect an interaction through inertial forces or orientation of the autonomous LEV 105. In some implementations, the autonomous LEV 105 can communicate data indicative of the orientation to a remote computing system 190. For example, image data from one or more cameras can be uploaded to the remote computing system 190.

In some implementations, the remote computing system 190 can dispatch one or more services in response to the interaction with the object. As an example, one or more backend control station or emergency services can be dispatched to provide emergency services to a rider and/or to retrieve an autonomous LEV 105.

In some implementations, the control action can be determined based at least in part on a rider profile 143. For example, the rider profile 143 can be associated with a particular rider who is currently operating the autonomous LEV 105. The rider profile 143 can include information about the rider. For example, in some implementations, the rider profile 143 can include data regarding the rider's previous operation of autonomous LEVs 105, such as how fast the rider drives, how fast the rider decelerates, how quickly the rider turns, whether and how often the rider drives on pedestrian walkways, designated LEV travelways, or other surfaces, how the rider's weight has been distributed on the autonomous LEV 105, and other rider specific information.

In some implementations, the rider profile 143 can include a rider proficiency metric determined based at least in part on one or more previous autonomous LEV operating sessions for the rider. For example, the rider proficiency metric can be indicative of the overall proficiency of the rider, such as how safely the rider operates the autonomous LEV 105 and whether the rider abides by safety rules and regulations. For example, operating in autonomous LEV 105 on a designated travel way where available, rather than a pedestrian walkway, can positively impact a rider proficiency metric. Similarly, responding to pedestrians in a safe way, such as by traveling around pedestrians, decelerating in response to pedestrians, or avoiding pedestrian walkways when pedestrians are present, can similarly positively impact the rider proficiency metric. Conversely, operating the autonomous LEV unsafely can negatively impact the rider proficiency metric. For example, disregarding traffic regulations (e.g., posted speed limits, traffic signals, etc.) can negatively impact the rider proficiency metric. A rider's experience can similarly be included in a rider proficiency metric. For example, riders with more experience driving autonomous LEVs 105 can generally have higher rider proficiency metrics than riders with less experience.

In some implementations, a rider profile 143 can include real time data for a current operating session. For example, image data from a camera can be used to detect unsafe driving behaviors and limit control and/or adjust a rider profile 143 accordingly. As an example, a higher or lower speed threshold for a rider profile 143 can be determined based on the real time data. In various implementations, such real time data can include whether a payload (e.g., number of passengers, weight of objects, etc.) is below an applicable transport rating threshold, whether a rider is wearing a helmet while operating the autonomous LEV 105, visual modeling of a rider presence, such as whether the rider is oriented with proper contact points on the deck of the autonomous LEV 105 and/or on the handlebars of the autonomous LEV 105, whether the rider is distracted or vigilant (e.g., using his/her phone vs. looking ahead in the direction of travel) while operating the autonomous LEV 105, and/or whether the rider is detected as fatigued or otherwise impaired.

In some implementations, the rider proficiency metric can be used to determine whether and when to implement a control action to modify operation of the autonomous LEV in response to detecting an object and/or a potential interaction. For example, the autonomy system 140 can intervene more quickly for a rider with a lower proficiency metric than a rider with a higher proficiency metric. For example, the autonomy system 140 can intervene earlier for a rider approaching a pedestrian (e.g., at a further distance from the pedestrian) for a rider with a lower proficiency metric than a rider with a higher proficiency metric by, for example, decelerating earlier. In some implementations, riders which have a higher rider proficiency metric may be allowed to operate an autonomous LEV 105 at a higher maximum speed. Similarly, riders who wear appropriate safety equipment, such as safety helmet, may be allowed to operate the autonomous LEV 105 at an increased maximum speed. For example, image data obtained from a 360 degree camera can detect that a rider is wearing a safety helmet, and in response, determine the rider has an increased rider proficiency metric.

The remote computing system 190 can include one or more computing devices that are remote from the autonomous LEV 105 (e.g., located off-board the autonomous LEV 105). For example, such computing device(s) can be components of a cloud-based server system and/or other type of computing system that can communicate with the LEV computing system 100 of the autonomous LEV 105, another computing system (e.g., a vehicle provider computing system, etc.), a user computing system (e.g., rider's smart phone), etc. The remote computing system 190 can be or otherwise included in a data center for the service entity, for example. The remote computing system 190 can be distributed across one or more location(s) and include one or more sub-systems. The computing device(s) of a remote computing system 190 can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system (e.g., the one or more processors, etc.) to perform operations and functions, such as communicating data to and/or obtaining data from autonomous LEVs 105.

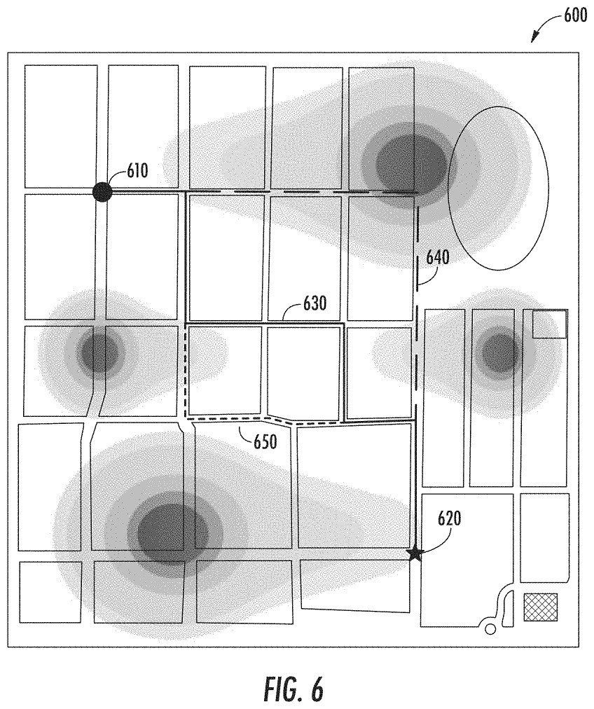

As will be described in greater detail with respect to FIG. 6, in some implementations, the remote computing system 190 can receive data indicative of an object density (e.g., detected object data 156) from a plurality of autonomous LEVs 105. Further, the remote computing system 190 can determine aggregated object density for a geographic area based at least in part on the data indicative of the pedestrian density obtained from the plurality of autonomous LEVs 105.

For example, each of a plurality of autonomous LEV's 105 can communicate a respective data indicative of a pedestrian density to the remote computing system 190. The data indicative of the pedestrian density from an autonomous LEV 105 can include, for example, a pedestrian count (e.g., a number of pedestrians detected by the autonomous LEV 105), a pedestrian location (e.g., a location of one or more individual pedestrian locations and/or a location of the autonomous LEV), an orientation of one or more pedestrians with respect to the autonomous LEV, and/or other data indicative of a pedestrian density.

In some implementations, the data indicative of the object density can include, for example, detected object data 156, as described herein. In some implementations, the data indicative of the object density can include, for example, sensor data obtained from an autonomous LEV 105. For example, image data from a 360 degree camera can be obtained from an autonomous LEV 105. The data indicative of the object density can be anonymized before being uploaded by the autonomous LEVs 105 by, for example, blurring individual pedestrian features in an image or uploading anonymized information, such as only the location for individual pedestrians.

The remote computing system 190 can then determine aggregated object density for a geographic area based at least in part on the data indicative of the object density obtained from the plurality of autonomous LEVs 190. For example, the aggregated object density can map the data indicative of the object density obtained from the plurality of autonomous LEVs. As an example, the aggregated object density can be a “heat map” depicting areas of varying pedestrian density within the geographic area. In some implementations, data indicative of an object density obtained from two or more nearby autonomous LEVs 105 can be analyzed to remove duplicate objects in the aggregated object density. An example aggregated object density will be discussed in greater detail with respect to FIG. 6.

In some implementations, the remote computing system 190 can further control an operation of at least one autonomous LEV 105 within the geographic area based at least in part on the aggregated object density for the geographic area. For example, in some implementations, controlling the operation of the at least one autonomous LEV 105 within the geographic area based at least in part on the aggregated object density for the geographic area can include determining one or more navigational instructions for the rider to navigate to a destination based at least in part on the aggregated object density for the geographic area.

For example, a rider of an autonomous LEV 105 can request one or more navigational instructions to a destination location using his or her smart phone. Data indicative of the destination can be uploaded to the remote computing system 190, and the remote computing system can then use a routing algorithm to determine one or more navigational instructions to travel from the rider's current location to the destination location.

According to example aspects of the present disclosure, the remote computing system 190 can determine the one or more navigational instructions to the destination based at least in part on the aggregated object density for the geographic area. For example, routes traveling through areas with high pedestrian density can be avoided, whereas areas routes traveling through areas with low pedestrian density can be preferred. Similarly, routes with high vehicle density (e.g., heavy traffic or congested areas) can be avoided.

In some implementations, the remote computing system 190 can further determine the one or more navigational instructions based at least in part on a route score. For example, the route score can be determined based at least in part on an availability of autonomous LEV infrastructure within the geographic area. LEV infrastructure can include, for example, designated LEV travel ways, designated LEV parking facilities, LEV collection points, LEV charging locations, and/or other infrastructure for use by LEVs. For example, routes that include designated travel ways for LEVs can be preferred, while routes that do not include designated travel ways can be avoided.

In some implementations, the remote computing system 190 can communicate the one or more navigational instructions to the autonomous LEV 105. The one or more navigational instructions can then be provided to the rider of the autonomous LEV 105 by a user interface of the autonomous LEV. In some implementations, a haptic device 181 can be used to provide the one or more navigational instructions to the rider. For example, a left handlebar can vibrate to indicate the rider should make a left turn, and a right handlebar can vibrate to indicate the rider should make a right turn. In some implementations, an audio speaker 182 can be used to provide the one or more navigational instructions to the rider. For example, audible instructions (e.g., “turn right at the next intersection”) can be provided to the rider.

In some implementations, the remote computing system 190 can provide the one or more navigational instructions to a user computing device associated with the rider. For example, the one or more navigational instructions can be communicated to the rider's smart phone. In various implementations, the one or more navigational instructions can be displayed on a screen of the smart phone, such as an overview showing the route from the rider's current location to the destination and/or turn by turn navigational instructions. In some implementations, cues can be provided to the rider, such as audible cues to turn (e.g., “turn right”) and/or haptic responses (e.g., vibrations, etc.).

In some implementations, the remote computing system 190 can control the operation of the at least one autonomous LEV 105 within the geographic area based at least in part on the aggregated object density for the geographic area by limiting an operation of the at least one autonomous vehicle within a subset of the geographic area based at least in part on the aggregated object density for the geographic area. For example, in some implementations, the remote computing system 190 can send one or more commands to an autonomous LEV 105 which can limit a maximum speed of the autonomous LEV 105 within the subset of the geographic area. For example, while the autonomous LEV 105 is located within the subset of the geographic area (e.g., a one block radius of a high pedestrian density), the autonomous LEV 105 can only be operated up to the maximum speed threshold. Once the autonomous LEV 105 has left the subset of the geographic area, the maximum speed limitation can be removed.

In some implementations, the remote computing system 190 can send one or more commands to an autonomous LEV 105 which can limit an area of a travel way in which the at least one autonomous LEV 105 can operate within the subset of the geographic area. For example, the autonomous LEV 105 may be prevented from operating on a pedestrian travelway (e.g., a sidewalk) in areas with a high pedestrian density. In some implementations, the remote computing system 190 can similarly prevent an autonomous LEV 105 from operating on a sidewalk where applicable regulations (e.g., municipal regulations) do not allow for such operation.

In some implementations, the remote computing system 190 can send one or more commands to an autonomous LEV 105 which can prohibit (e.g., prevent) the autonomous LEV 105 from operating within the subset of the geographic area. For example, a rider of an autonomous LEV 105 can be notified that autonomous LEV operation is restricted in certain areas, such as by sending a push notification to the rider's smart phone or via the HMI 180 of the autonomous LEV 105. Should the rider disregard the notification and attempt to operate the autonomous LEV 105 within the restricted area, the LEV 105 can be controlled to a stop. Further, operation of the autonomous LEV 105 can be disabled until such time as the restriction is lifted or the rider acknowledges the restriction and navigates away from the restricted area.

Referring now to FIG. 2, a top-down perspective of an example autonomous LEV 200 according to example aspects of the present disclosure is depicted. For example, the autonomous LEV 200 depicted is an autonomous scooter. The autonomous LEV 200 can correspond to an autonomous LEV 105 depicted in FIG. 1.

As shown, the autonomous LEV 200 can include a steering column 210, a handlebar 220, a rider platform 230, a front wheel 240 (e.g., steering wheel), and a rear wheel 250 (e.g., drive wheel). For example, a rider can operate the autonomous LEV 200 in a manual mode in which the rider stands on the rider platform 230 and controls operation of the autonomous LEV 200 using controls on the handlebar 220. In some implementations, one or more haptic devices can be incorporated into a handlebar 220, as described herein.

In some implementations, the autonomous LEV 200 can include a 360 degree camera 260 mounted on the steering column 210. The 360 degree camera 260 can be configured to obtain image data in a 360 degree field of view.

In some implementations, one or more pressure sensors, torque sensors, and/or force sensors can be incorporated into the rider platform 230 and/or the wheels 240/250. For example, a first pressure sensor can be incorporated into a forward portion of the rider platform 230 (e.g., towards the steering column 210) and a second pressure sensor can be incorporated into a rear portion of the rider platform 230 (e.g., near a rear wheel 250). In some implementations, the one or more sensors can be incorporated into the chassis linkages, such as suspension joints. In some implementations, one or more pressure/force sensors can be incorporated into a grip on the handlebar 220. Further, one or more heart rate, moisture, and/or temperature sensors can similarly be incorporated into the handlebar 220.

As described herein, data obtained from the sensors can be used, for example, to determine a weight distribution of a payload onboard the rider platform 230. For example, the weight distribution of the payload (e.g., a rider and any other items onboard the autonomous LEV 200) can be determined based on the respective forces applied to the sensors by the payload. In some implementations, the weight distribution of the payload can be monitored during operation of the autonomous LEV 200, such as during deceleration/acceleration of the autonomous LEV 200 in response to determining that a likelihood of an interaction with an object exists.

In some implementations, image data obtained from the 360 degree camera 260 can similarly be used to determine the weight distribution of the payload onboard the autonomous LEV 200. For example, consecutive image frames can be analyzed to determine whether the rider's position onboard the autonomous LEV is shifting due to deceleration/acceleration of the autonomous LEV 200.

In some implementations, rolling resistance sensors in the front wheel 240 and/or the rear wheel 250 can be used to determine the weight distribution of the payload onboard the autonomous LEV 200. For example, variations in the respective readings of the rolling resistance sensors can be indicative of the proportion of the payload distributed near each respective wheel 240/250.

The autonomous LEV 200 can include various other components (not shown), such as sensors, actuators, batteries, computing devices, communication devices, and/or other components as described herein.

Referring now to FIG. 3A, an example image 300 depicting a walkway 310, a street 320, and a plurality of objects 330 is depicted, and FIG. 3B depicts a corresponding semantic segmentation 350 of the image 300. For example, as shown, the semantically-segmented image 350 can be partitioned into a plurality of segments 360-389 corresponding to different semantic entities depicted in the image 300. Each segment 360-389 can generally correspond to an outer boundary of the respective semantic entity. For example, the walkway 310 can be semantically segmented into a distinct semantic entity 360, the road 320 can be semantically segmented into a distinct semantic entity 370, and each of the objects 330 can be semantically segmented into distinct semantic entities 381-389, as depicted. For example, semantic entities 381-384 are located on the walkway 360, whereas semantic entities 385-389 are located on the road 370. While the semantic segmentation depicted in FIG. 3 generally depicts the semantic entities segmented to their respective borders, other types of semantic segmentation can similarly be used, such as bounding boxes etc.

In some implementations, the semantically-segmented image 350 can be used to detect one or more objects in a surrounding environment of an autonomous LEV. For example, as depicted, a pedestrian 384 has been semantically segmented from the image 300. In some implementations, the pedestrian 384 can further be classified according to a type. For example, the pedestrian 384 can be classified as an adult, child, walking pedestrian, running pedestrian, a pedestrian in a wheelchair, a pedestrian using a personal mobility device, a pedestrian on skateboards, and/or any other type of pedestrian. Other objects can similarly be classified.

In some implementations, individual sections of a walkway 310 and/or a ground plane can also be semantically segmented. For example, an image segmentation and classification model 151, a ground plane analysis model 152, and/or a walkway detection model 153 depicted in FIG. 1 can be trained to semantically segment an image into one or more of a ground plane, a road, a walkway, etc. For example, a ground plane can include a road 370 and a walkway 360. Further, in some implementations, the walkway 360 can be segmented into various sections, as described in greater detail with respect to FIG. 4.

Referring now to FIG. 4, an example walkway 400 and walkway sections 410-440 according to example aspects of the present disclosure are depicted. As shown, a walkway 400 can be divided up into one or more sections, such as a first section (e.g., frontage zone 410), a second section (e.g., pedestrian throughway 420), a third section (e.g., furniture zone 430), and/or a fourth section (e.g., travel lane 440). The walkway 400 depicted in FIG. 4 can be, for example, a walkway depicted in an image obtained from a camera onboard an autonomous LEV, and thus from the perspective of the autonomous LEV.

A frontage zone 410 can be a section of the walkway 400 closest to one or more buildings 405. For example, the one or more buildings 405 can correspond to dwellings (e.g., personal residences, multi-unit dwellings, etc.), retail space (e.g., office buildings, storefronts, etc.) and/or other types of buildings. The frontage zone 410 can essentially function as an extension of the building, such as entryways, doors, walkway café s, sandwich boards, etc. The frontage zone 410 can include both the structure and the façade of the buildings 405 fronting the street 450 as well as the space immediately adjacent to the buildings 405.

The pedestrian throughway 420 can be a section of the walkway 400 that functions as the primary, accessible pathway for pedestrians that runs parallel to the street 450. The pedestrian throughway 420 can be the section of the walkway 400 between the frontage zone 410 and the furniture zone 430. The pedestrian throughway 420 functions to help ensure that pedestrians have a safe and adequate place to walk. For example, the pedestrian throughway 420 in a residential setting may typically be 5 to 7 feet wide, whereas in a downtown or commercial area, the pedestrian throughway 420 may typically be 8 to 12 feet wide. Other pedestrian throughways 420 can be any suitable width.

The furniture zone 430 can be a section of the walkway 400 between the curb of the street 450 and the pedestrian throughway 420. The furniture zone 430 can typically include street furniture and amenities such as lighting, benches, newspaper kiosks, utility poles, trees/tree pits, as well as light vehicle parking spaces, such as designated parking spaces for bicycles and LEVs.

Some walkways 400 may optionally include a travel lane 440. For example, the travel lane 440 can be a designated travel way for use by bicycles and LEVs. In some implementations, a travel lane 440 can be a one-way travel way, whereas in others, the travel lane 440 can be a two-way travel way. In some implementations, a travel lane 440 can be a designated portion of a street 450.

Each section 410-440 of a walkway 400 can generally be defined according to its characteristics, as well as the distance of a particular section 410-440 from one or more landmarks. For example, in some implementations, a frontage zone 410 can be the 6 to 8 feet closest to the one or more buildings 405. In some implementations, a furniture zone 430 can be the 6 to 8 feet closest to the street 450. In some implementations, the pedestrian throughway 420 can be the 5 to 12 feet in the middle of a walkway 400. In some implementations, each section 410-440 can be determined based upon characteristics of each particular section 410-440, such as by semantically segmenting an image using an image segmentation and classification model 151, a ground plane analysis model 152, and/or a walkway detection model 153 depicted in FIG. 1. For example, street furniture included in a furniture zone 430 can help to distinguish the furniture zone 430, whereas sandwich boards and outdoor seating at walkway café s can help to distinguish the frontage zone 410. In some implementations, the sections 410-440 of a walkway 400 can be defined, such as in a database. For example, a particular location (e.g., a position) on a walkway 400 can be defined to be located within a particular section 410-440 of the walkway 400 in a database, such as a map data 130 database depicted in FIG. 1. In some implementations, the sections 410-440 of a walkway 400 can have general boundaries such that the sections 410-440 may have one or more overlapping portions with one or more adjacent sections 410-440.

Referring now to FIG. 5, an example scenario 500 depicting an object detection and interaction determination is shown. The example scenario 500 can be used, for example, by a computing system of an autonomous LEV to detect one or more objects as well as determine that the autonomous LEV has a likelihood of interacting with an object.

For example, as shown, and autonomous LEV 510 is traveling along a route 515. The autonomous LEV 510 can correspond to, for example, the autonomous LEVs 105 and 200 depicted in FIGS. 1 and 2. The route 515 can be, for example, an expected path of travel based on a current heading and velocity of the autonomous LEV 510.

Further, as shown, a first object (e.g., a first pedestrian) 520 and a second object (e.g., a second pedestrian) 530 are also depicted. Each of the pedestrians 520/530 can be detected by the autonomous LEV 510 by, for example, semantically segmenting image data obtained from a camera onboard the autonomous LEV 510. For example, in some implementations, a 360 degree camera can obtain image data for a field of view around the entire autonomous LEV 510. In some implementations, a subset of the field of view of the 360 degree camera can be selected for object detection analysis. For example, a portion of a 360 degree image corresponding to the area in front of the autonomous LEV 510 generally along the route 515 can be selected for image analysis.

According to example aspects of the present disclosure, in some implementations, a respective predicted future motion 525/535 for the pedestrians 520/530 can also be determined by the computing system onboard the autonomous LEV 510. For example, by analyzing multiple frames of image data, a respective heading and velocity for each of the pedestrians 520 can be determined, which can be used to determine a predicted future motion 525/535 for the pedestrians 520/530 respectively. The image data can be analyzed by, for example, one or machine-learned models, as described herein. In some implementations, the predicted future motions 525/535 can further be determined based at least in part on a type of object. For example, a predicted future motion for a running pedestrian (e.g., predicted future motion 525 for pedestrian 520) may include travel over a greater respective distance over a period of time than a predicted future motion for a walking pedestrian (e.g., predicted future motion 535 for pedestrian 530).

In some implementations, the computing system onboard the autonomous LEV 510 can determine that the autonomous LEV 510 has a likelihood of interacting with an object based at least in part on image data obtained from a camera located onboard the autonomous LEV 510. For example, each of the predicted future motions 525/535 for the pedestrians 520/530 can correspond to the autonomous LEV 510 occupying the same point as the pedestrians 520/530 along the route 515 at the same time. Stated differently, the predicted future motions 525/535 for the pedestrians 520/530 and the route 515 for the autonomous LEV 510 can intersect at the same time, thereby indicating a likelihood of an interaction.

In response to determining that the autonomous LEV 510 has the likelihood interacting with the objects 520/530, the computing system onboard the autonomous LEV 510 can determine a control action to modify an operation of the autonomous LEV 510. Further, the computing system can implement the control action, as described herein.

For example, in some implementations, the control action can be determined based at least in part on an estimated distance to a pedestrian 520/530. For example, one or more thresholds can be used. As an example, a first deceleration rate can be used to decelerate the autonomous LEV 510 in response to a likelihood of interacting with the first pedestrian 520, whereas a second deceleration rate can be used to decelerate the autonomous LEV 510 in response to the second pedestrian 530. For example, the first deceleration rate can be a greater (e.g., more aggressive) deceleration rate then the second deceleration rate in order to stop or slow the autonomous LEV 510 more quickly, as the first pedestrian 520 is closer to the autonomous LEV 510.

In some implementations, as described herein, the control action to modify the operation of the autonomous LEV 510 can be determined based at least in part on a weight distribution of the payload onboard the autonomous LEV 510. For example, sensor data obtained from one or more pressure sensors, torque sensors, force sensors, cameras, and/or rolling resistance sensors can be used to determine a weight distribution of the payload onboard the autonomous LEV 510, and the control action can be determined based at least in part on the weight distribution.

In some implementations, as described herein, the control action to modify the operation of the autonomous LEV 510 can be determined based at least in part on a rider profile associated with a rider of the autonomous LEV 510. For example, the rider profile can include a rider proficiency metric determined based at least in part on one or more previous autonomous LEV operating sessions for the rider of the autonomous LEV 510.

In various implementations, the control action can include limiting a maximum speed of the autonomous LEV 510, decelerating the autonomous LEV 510, bringing the autonomous LEV 510 to a stop, providing an audible alert to the rider of the autonomous LEV 510, providing a haptic response to the rider of the autonomous LEV 510, and/or sending an alert to a computing device associated with a rider of the autonomous LEV 510, as described herein.

Referring now to FIG. 6, an example navigation path analysis for an autonomous LEV according to example aspects of the present disclosure is depicted. The example navigation path analysis depicted can be performed by, for example, a remote computing system remote from one or more autonomous LEVs, such as a remote computing system 190 depicted in FIG. 1.

As shown, an example map of a geographic area 600 (e.g., a downtown area) is depicted. Additionally, the map shows an aggregated object density for the geographic area 600 as a “heat map.” For example, as depicted in FIG. 6, areas with higher pedestrian density, are depicted with darker shading, while areas with lower to no pedestrian density are shown with lighter or no shading. The “heat map” depicted in FIG. 6 is a visual representation of an aggregated object density for the geographic area 600, which can be determined using data indicative of an object density obtained by a remote computing system from a plurality of autonomous LEVs, as described herein. An aggregated object density can be represented in other suitable means, and for objects other than pedestrians (e.g., vehicles).

According to example aspect of the present disclosure, the remote computing system can obtain data indicative of a destination 620 for a rider of an autonomous LEV. For example, in some implementations, a rider can use his or her user computing device (e.g., smart phone) to request one or more navigational instructions to a particular destination 620. The request for the one or more navigational instructions can be communicated to the remote computing system over a communications network.

In some implementations, the remote computing system can then determine the one or more navigational instructions for the rider to travel from an origin 610 to the destination 620. The origin 610 can be, for example, the then current location of the rider and/or the then current location of an autonomous LEV associated with the rider. For example, in some implementations, the rider can use an app on his or her smart phone to rent a nearby autonomous LEV.

The remote computing system can then determine one or more navigational instructions for the rider to travel from the origin 610 to the destination 620. For example, in some implementations, the remote computing system can control the operation of an autonomous LEV associated with the rider by determining one or more navigational instructions for the rider to navigate to the destination 620 based at least in part on the aggregated object density for the geographic area 600. As an example, the remote computing system can determine the one or more navigational instructions to reduce, and in some cases, minimize, traveling through areas with heavy pedestrian density. Similarly, geographic areas in which historical operational data indicate object interactions are more likely to occur can be avoided.

For example, three possible routes 630, 640, and 650 are shown for traveling from the origin 6102 the destination 620. The first route 630 includes five turns, whereas the second route 640 includes only one turn and the third route 650 includes three turns. The first route 630, however, travels through areas with zero to light pedestrian density, while the second route 640 travels through an area with the highest level of pedestrian density. In some implementations, the remote computing system can select the first route 630 rather than the second route 640 in order to avoid areas with high object (e.g., pedestrian) density. Stated differently, the remote computing system can route the rider around areas with higher pedestrian (or other object) density, even at the expense of providing more complex directions, such as directions with more turns.

In some implementations, the one or more navigational instructions can further be determined based at least in part on a route score. For example, in some implementations, the first route 630 may avoid areas with high pedestrian density, but may not have autonomous LEV infrastructure, such as a designated travel way. The third route 650, however, may include sections of travel ways which do include autonomous LEV infrastructure, such as designated travel ways. In some implementations, the remote computing system can select the third route 650 rather than the first route 630, as the third route 650 may have a higher route score due to the available autonomous LEV infrastructure. Further, the route score for the third route 650 may be higher than the route score for the first route 630 as the areas of pedestrian congestion along the third route 650 are in areas in which autonomous LEV infrastructure is available, which can help to mitigate the higher pedestrian density along the third route 650.

In various implementations, additional data can be used to determine a route score. As examples, a road segment safety metric can be determined, such as by using image data from a camera to analyze how well lit a road segment is. Similarly, historical data for a road segment (e.g., data indicative of previous object interactions) can be used to more dangerous road segments. In some implementations, rider experiences with road segments can be analyzed, such as by detecting facial expressions of a rider using image data from a camera. Similarly, power consumption (e.g., as measured in time, energy, battery usage, etc.) data can be used to avoid road segments which use increased resources as compared to other road segments. Additionally, roadway features, such as potholes, drains, grates, etc. can also be used to determine a route score.

Thus, as depicted in FIG. 6, in some implementations, the one or more navigational instructions provided to a rider can be determined based at least in part on an aggregated object density for a geographic area. Further, in some implementations, the one or more navigational instructions for the rider to navigate to the destination can be further determined based at least in part on a route score. For example, the route score can prioritize routes which are able to make use of available autonomous LEV infrastructure.

Further, in some implementations, the remote computing system can control the operation of autonomous LEVs by, for example, limiting a maximum speed of an autonomous LEV, such as in areas with moderate pedestrian density, prohibiting operation in certain areas, such as areas with heavy pedestrian density, and limiting operation to an area of a travel way, such as on a designated travel way rather than a pedestrian throughway.

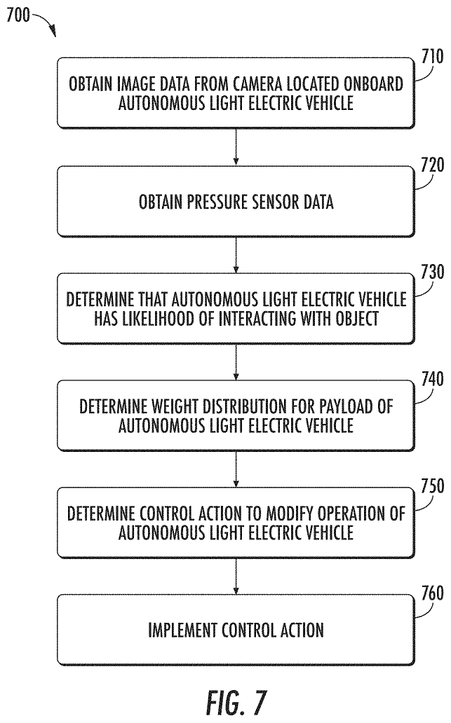

FIG. 7 depicts a flow diagram of an example method 700 for detecting objects and controlling an autonomous LEV according to example aspects of the present disclosure. One or more portion(s) of the method 700 can be implemented by a computing system that includes one or more computing devices such as, for example, the computing systems described with reference to the other figures (e.g., a LEV computing system 100, a remote computing system 190, etc.). Each respective portion of the method 700 can be performed by any (or any combination) of one or more computing devices. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 7 is described with reference to elements/terms described with respect to other systems and figures for example illustrated purposes and is not meant to be limiting. One or more portions of method 700 can be performed additionally, or alternatively, by other systems.

At 710, the method 700 can include obtaining image data from a camera located onboard an autonomous LEV. For example, in some implementations, the image data can be obtained from a 360 degree camera located onboard the autonomous LEV. In some implementations, a subset of the image data can be selected for analysis, such as a field of view corresponding to an area in front of the autonomous LEV.

At 720, the method 700 can include obtaining pressure sensor, torque sensor, and/or force sensor data. For example, the sensor data can be obtained from one or more pressure sensors mounted to a rider platform of an autonomous LEV. In some implementations, the one or more pressure sensors can be one or more air pressure sensors configured to measure an air pressure within a front wheel and/or a rear wheel of an autonomous LEV.

At 730, the method 700 can include determining that the autonomous LEV has a likelihood of interacting with an object. For example, the image data can be analyzed using a machine-learned model to detect one or more objects (e.g., pedestrians). In some implementations, the one or more objects can be classified into a respective type of object. In some implementations, a predicted future motion for each detected object can be determined. In some implementations, determining that the autonomous LEV has the likelihood of interacting with an object can be determined by comparing the predicted future motion of an object with a predicted future motion (e.g., extrapolated future motion) of the autonomous LEV.

At 740, the method 700 can include determining a weight distribution for a payload of the autonomous LEV. For example, using the pressure sensor data, a weight distribution for a payload onboard the autonomous LEV can be determined.

At 750, the method 700 can include determining a control action to modify operation of the autonomous LEV. For example, in some implementations, the control action can include limiting a maximum speed of the autonomous LEV, decelerating the autonomous LEV, bringing the autonomous LEV to a stop, providing an audible alert to a rider of the autonomous LEV, providing a haptic response to a rider of the autonomous LEV, and/or sending an alert to a computing device associated with a rider of the autonomous LEV.

In some implementations, the control action can be determined based at least in part on the weight distribution for the payload of the autonomous LEV. For example, the weight distribution of the payload can be monitored and the deceleration or acceleration of the autonomous LEV can be dynamically controlled based at least in part on the weight distribution to reduce the likelihood that the rider loses control and/or falls off the autonomous LEV in response to the deceleration or acceleration.

At 760, the method 700 can include implementing the control action. For example, the vehicle autonomy system can send one or more commands (e.g., brake commands) to the vehicle control system, which can then cause the autonomous vehicle to implement the control action.

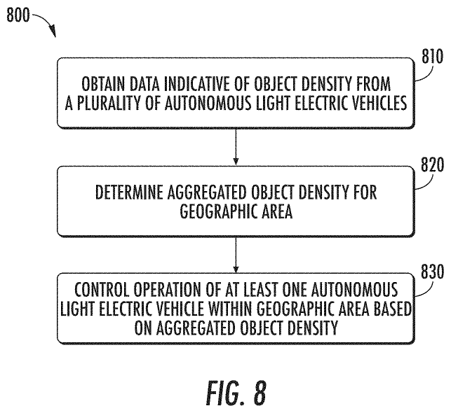

FIG. 8 depicts a flow diagram of an example method 800 for determining an aggregated object density for a geographic area and controlling an autonomous LEV according to example aspects of the present disclosure. One or more portion(s) of the method 800 can be implemented by a computing system that includes one or more computing devices such as, for example, the computing systems described with reference to the other figures (e.g., a LEV computing system 100, a remote computing system 190, etc.). Each respective portion of the method 800 can be performed by any (or any combination) of one or more computing devices. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 8 is described with reference to elements/terms described with respect to other systems and figures for example illustrated purposes and is not meant to be limiting. One or more portions of method 800 can be performed additionally, or alternatively, by other systems.

At 810, the method 800 can include obtaining data indicative of an object density from a plurality of autonomous LEVs. For example, in some implementations, each of a plurality of autonomous LEVs can communicate object density data to the remote computing system. In some implementations, the data indicative of an object density can include, for example, data indicative of a number of objects (e.g., pedestrians), data indicative of the location of one or more objects, the location of an autonomous LEV, and/or other data indicative of an object density as described herein.

At 820, the method 800 can include determining an aggregated object density for a geographic area based at least in part on the data indicative of the object density obtained from the plurality of autonomous LEVs. For example, in some implementations, the aggregated object density can be visually represented as a “heat map.” Other suitable aggregations of object density data can similarly be determined. Various object density classifications and/or thresholds can be used, such as low, moderate, high, etc.

At 830, the method 800 can include controlling operation of at least one autonomous LEV within a geographic area based at least in part on the aggregated object density. For example, in some implementations, a remote computing system can obtain data indicative of a destination for a rider of an autonomous LEV. Further, controlling the operation of an autonomous LEV within the geographic area can include determining one or more navigational instructions for the rider to navigate to the destination based at least in part on the aggregated object density for the geographic area. For example, the one or more navigational instructions can be determined to route the rider around areas with heavy pedestrian densities.

In some implementations, the one or more navigational instructions can further be determined based at least in part on a route score. For example, a route score can be determined based at least in part on an availability of autonomous LEV infrastructure within the geographic area. As an example, routes with available designated LEV travel ways can be scored higher than routes that do not have designated LEV travel ways.

In some implementations, the one or more navigational instructions can be provided to a rider of the autonomous LEV by a user interface of the autonomous LEV. For example, in some implementations, a haptic device incorporated in the handlebar of the autonomous LEV can provide vibratory cues to a rider to indicate when to turn left or right. In some implementations, the one or more navigational instructions can be provided to a user computing device associated with the rider, such as a rider's smart phone.

In some implementations, controlling the operation of an autonomous LEV within a geographic area can include limiting a maximum speed of the autonomous LEV, limiting an area of a travel way in which the autonomous LEV can operate, and/or prohibiting the autonomous LEV from operating within a geographic area (or subset thereof).

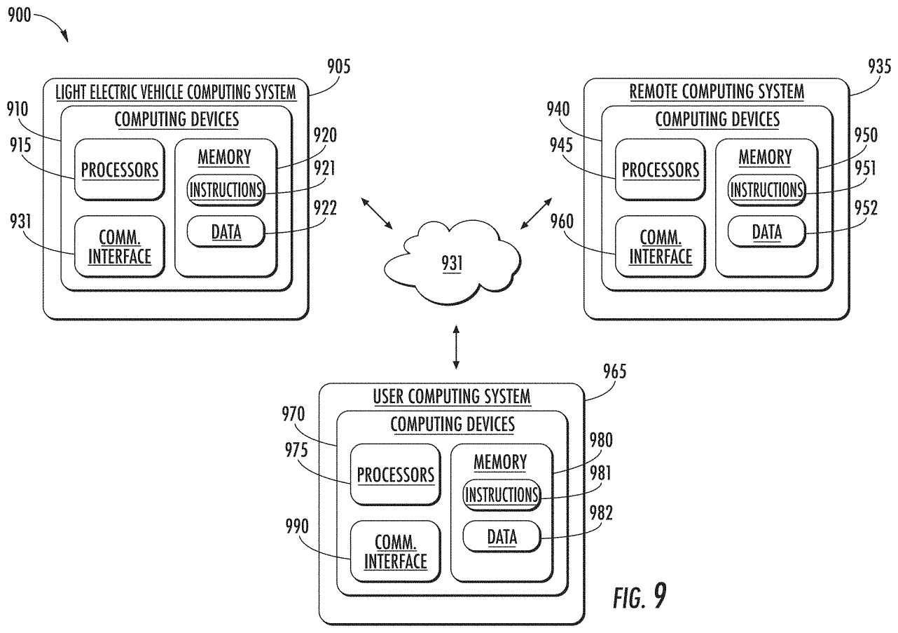

FIG. 9 depicts an example system 900 according to example aspects of the present disclosure. The example system 900 illustrated in FIG. 9 is provided as an example only. The components, systems, connections, and/or other aspects illustrated in FIG. 9 are optional and are provided as examples of what is possible, but not required, to implement the present disclosure. The example system 900 can include a light electric vehicle computing system 905 of a vehicle. The light electric vehicle computing system 905 can represent/correspond to the light electric vehicle computing system 100 described herein. The example system 900 can include a remote computing system 935 (e.g., that is remote from the vehicle computing system). The remote computing system 935 can represent/correspond to a remote computing system 190 described herein. The example system 900 can include a user computing system 965. The user computing system 965 can represent/correspond to a user computing device, such as a rider's smart phone, as described herein. The light electric vehicle computing system 905, the remote computing system 935, and the user computing system 965 can be communicatively coupled to one another over one or more network(s) 931.

The computing device(s) 910 of the light electric vehicle computing system 905 can include processor(s) 915 and a memory 920. The one or more processors 915 can be any suitable processing device (e.g., a processor core, a microprocessor, an ASIC, a FPGA, a controller, a microcontroller, etc.) and can be one processor or a plurality of processors that are operatively connected. The memory 920 can include one or more non-transitory computer-readable storage media, such as RAM, ROM, EEPROM, EPROM, one or more memory devices, flash memory devices, data registrar, etc., and combinations thereof.

The memory 920 can store information that can be accessed by the one or more processors 915. For instance, the memory 920 (e.g., one or more non-transitory computer-readable storage mediums, memory devices) on-board the vehicle can include computer-readable instructions 921 that can be executed by the one or more processors 915. The instructions 921 can be software written in any suitable programming language or can be implemented in hardware. Additionally, or alternatively, the instructions 921 can be executed in logically and/or virtually separate threads on processor(s) 915.

For example, the memory 920 can store instructions 921 that when executed by the one or more processors 915 cause the one or more processors 915 (the light electric vehicle computing system 905) to perform operations such as any of the operations and functions of the LEV computing system 100 (or for which it is configured), one or more of the operations and functions for detecting objects and controlling the autonomous LEV, one or more portions of methods 700 and 800, and/or one or more of the other operations and functions of the computing systems described herein.

The memory 920 can store data 922 that can be obtained (e.g., acquired, received, retrieved, accessed, created, stored, etc.). The data 922 can include, for instance, sensor data, image data, object detection data, rider profile data, weight distribution data, navigational instruction data, data indicative of an object density, aggregated object density data, origin data, destination data, map data, regulatory data, vehicle state data, perception data, prediction data, motion planning data, autonomous LEV location data, travel distance data, travel time data, energy expenditure data, obstacle data, charge level data, operational status data, LEV infrastructure data, travel way data, machine-learned model data, route data, route score data, time data, operational constraint data, LEV charging location data, LEV designated parking location data, LEV collection point data, data associated with a vehicle client, data associated with a service entity's telecommunications network, data associated with an API, data associated with a library, data associated with user interfaces, data associated with user input, and/or other data/information such as, for example, that described herein. In some implementations, the computing device(s) 910 can obtain data from one or more memories that are remote from the light electric vehicle computing system 905.

The computing device(s) 910 can also include a communication interface 930 used to communicate with one or more other system(s) on-board a vehicle and/or a remote computing device that is remote from the vehicle (e.g., of the system 935). The communication interface 930 can include any circuits, components, software, etc. for communicating via one or more networks (e.g., network(s) 931). The communication interface 930 can include, for example, one or more of a communications controller, receiver, transceiver, transmitter, port, conductors, software and/or hardware for communicating data.

The remote computing system 935 can include one or more computing device(s) 940 that are remote from the light electric vehicle computing system 905. The computing device(s) 940 can include one or more processors 945 and a memory 950. The one or more processors 945 can be any suitable processing device (e.g., a processor core, a microprocessor, an ASIC, a FPGA, a controller, a microcontroller, etc.) and can be one processor or a plurality of processors that are operatively connected. The memory 950 can include one or more tangible, non-transitory computer-readable storage media, such as RAM, ROM, EEPROM, EPROM, one or more memory devices, flash memory devices, data registrar, etc., and combinations thereof.

The memory 950 can store information that can be accessed by the one or more processors 945. For instance, the memory 950 (e.g., one or more tangible, non-transitory computer-readable storage media, one or more memory devices, etc.) can include computer-readable instructions 951 that can be executed by the one or more processors 945. The instructions 951 can be software written in any suitable programming language or can be implemented in hardware. Additionally, or alternatively, the instructions 951 can be executed in logically and/or virtually separate threads on processor(s) 945.

For example, the memory 950 can store instructions 951 that when executed by the one or more processors 945 cause the one or more processors 945 to perform operations such as any of the operations and functions of the remote computing system 935 (or for which it is configured), one or more of the operations and functions for determining aggregated object densities and controlling autonomous LEVs, one or more portions of methods 700 and 800, and/or one or more of the other operations and functions of the computing systems described herein.

The memory 950 can store data 952 that can be obtained. The data 952 can include, for instance, sensor data, image data, object detection data, rider profile data, weight distribution data, navigational instruction data, data indicative of an object density, aggregated object density data, origin data, destination data, map data, regulatory data, vehicle state data, perception data, prediction data, motion planning data, autonomous LEV location data, travel distance data, travel time data, energy expenditure data, obstacle data, charge level data, operational status data, LEV infrastructure data, travel way data, machine-learned model data, route data, route score data, time data, operational constraint data, LEV charging location data, LEV designated parking location data, LEV collection point data, data associated with a vehicle client, data associated with a service entity's telecommunications network, data associated with an API, data associated with a library, data associated with user interfaces, data associated with user input, and/or other data/information such as, for example, that described herein. In some implementations, the computing device(s) 940 can obtain data from one or more memories that are remote from the remote computing system 935.

The computing device(s) 940 can also include a communication interface 960 used to communicate with one or more system(s) onboard a vehicle and/or another computing device that is remote from the system 935, such as light electric vehicle computing system 905. The communication interface 960 can include any circuits, components, software, etc. for communicating via one or more networks (e.g., network(s) 931). The communication interface 960 can include, for example, one or more of a communications controller, receiver, transceiver, transmitter, port, conductors, software and/or hardware for communicating data.

The user computing system 965 can include one or more computing device(s) 970 that are remote from the light electric vehicle computing system 905 and the remote computing system 935. For example, the user computing system 965 can be associated with a rider of an autonomous LEV. The computing device(s) 970 can include one or more processors 975 and a memory 980. The one or more processors 975 can be any suitable processing device (e.g., a processor core, a microprocessor, an ASIC, a FPGA, a controller, a microcontroller, etc.) and can be one processor or a plurality of processors that are operatively connected. The memory 980 can include one or more tangible, non-transitory computer-readable storage media, such as RAM, ROM, EEPROM, EPROM, one or more memory devices, flash memory devices, data registrar, etc., and combinations thereof.

The memory 980 can store information that can be accessed by the one or more processors 975. For instance, the memory 980 (e.g., one or more tangible, non-transitory computer-readable storage media, one or more memory devices, etc.) can include computer-readable instructions 981 that can be executed by the one or more processors 975. The instructions 981 can be software written in any suitable programming language or can be implemented in hardware. Additionally, or alternatively, the instructions 981 can be executed in logically and/or virtually separate threads on processor(s) 975.

For example, the memory 980 can store instructions 981 that when executed by the one or more processors 975 cause the one or more processors 975 to perform operations such as any of the operations and functions of the user computing system 965 (or for which it is configured), one or more of the operations and functions for requesting navigational instructions, one or more portions of methods 700 and 800, and/or one or more of the other operations and functions of the computing systems described herein.

The memory 980 can store data 982 that can be obtained. The data 982 can include, for instance, sensor data, image data, object detection data, rider profile data, weight distribution data, navigational instruction data, data indicative of an object density, aggregated object density data, origin data, destination data, map data, regulatory data, vehicle state data, perception data, prediction data, motion planning data, autonomous LEV location data, travel distance data, travel time data, energy expenditure data, obstacle data, charge level data, operational status data, LEV infrastructure data, travel way data, machine-learned model data, route data, route score data, time data, operational constraint data, LEV charging location data, LEV designated parking location data, LEV collection point data, data associated with a vehicle client, data associated with a service entity's telecommunications network, data associated with an API, data associated with a library, data associated with user interfaces, data associated with user input, and/or other data/information such as, for example, that described herein. In some implementations, the computing device(s) 970 can obtain data from one or more memories that are remote from the remote computing system 965.

The computing device(s) 970 can also include a communication interface 990 used to communicate with one or more system(s) onboard a vehicle and/or another computing device that is remote from the system 965, such as light electric vehicle computing system 905. The communication interface 990 can include any circuits, components, software, etc. for communicating via one or more networks (e.g., network(s) 931). The communication interface 990 can include, for example, one or more of a communications controller, receiver, transceiver, transmitter, port, conductors, software and/or hardware for communicating data.

The network(s) 931 can be any type of network or combination of networks that allows for communication between devices. In some embodiments, the network(s) 931 can include one or more of a local area network, wide area network, the Internet, secure network, cellular network, mesh network, peer-to-peer communication link and/or some combination thereof and can include any number of wired or wireless links. Communication over the network(s) 931 can be accomplished, for instance, via a communication interface using any type of protocol, protection scheme, encoding, format, packaging, etc.

Computing tasks, operations, and functions discussed herein as being performed at one computing system herein can instead be performed by another computing system, and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for controlling an autonomous light electric vehicle, comprising:
obtaining, by a computing system comprising one or more computing devices positioned onboard an autonomous light electric vehicle, image data from a camera located onboard the autonomous light electric vehicle;
determining, by the computing system, that the autonomous light electric vehicle has a likelihood of interacting with an object based at least in part on the image data;
in response to determining that the autonomous light electric vehicle has the likelihood of interacting with the object, determining, by the computing system, a control action to modify an operation of the autonomous light electric vehicle; and
implementing, by the computing system, the control action.

2. The computer-implemented method of claim 1, wherein the operations further comprise determining, by the computing system, a weight distribution of a payload onboard the autonomous light electric vehicle; and
wherein determining, by the computing system, the control action to modify the operation of the autonomous light electric vehicle comprises determining, by the computing system, the control action based at least in part on the weight distribution of the payload.

3. The computer-implemented method of claim 2, wherein the weight distribution of the payload onboard the autonomous light electric vehicle is determined based at least in part on sensor data obtained from one or more sensors onboard the autonomous light electric vehicle; and
wherein the one or more sensors comprise one or more of: a pressure sensor, torque sensor, force sensor, the camera, and a rolling resistance sensor.

4. The computer-implemented method of claim 1, wherein determining, by the computing system, the control action to modify the operation of the autonomous light electric vehicle comprises determining, by the computing system, the control action based at least in part on a rider profile associated with a rider of the autonomous light electric vehicle.

5. The computer-implemented method of claim 4, wherein the rider profile comprises a rider proficiency metric determined based at least in part on one or more previous autonomous light electric vehicle operating sessions for the rider of the autonomous light electric vehicle.

6. The computer-implemented method of claim 1, wherein determining, by the computing system, that the autonomous light electric vehicle has the likelihood of interacting with the object comprises selecting a subset of a field of view of the image data.

7. The computer-implemented method of claim 1, wherein determining, by the computing system, that the autonomous light electric vehicle has the likelihood of interacting with the object comprises detecting the object using a machine-learned model.

8. The computer-implemented method of claim 1, wherein determining, by the computing system, that the autonomous light electric vehicle has the likelihood of interacting with the object comprises classifying a type of the object.

9. The computer-implemented method of claim 1, wherein determining, by the computing system, that the autonomous light electric vehicle has the likelihood of interacting with the object comprises determining a predicted future motion of the object.

10. The computer-implemented method of claim 1, wherein the control action comprises one or more of: limiting a maximum speed of the autonomous light electric vehicle, decelerating the autonomous light electric vehicle, bringing the autonomous light electric vehicle to a stop, providing an audible alert to the rider of the autonomous light electric vehicle, providing a haptic response to the rider of the autonomous light electric vehicle, and sending an alert to a computing device associated with a rider of the autonomous light electric vehicle.

11. The computer-implemented method of claim 1, wherein the control action is further determined based at least in part on an estimated distance to the object.

12. The computer-implemented method of claim 1, wherein the camera comprises a 360 degree camera.

13. A computing system, comprising:
one or more processors; and
one or more tangible, non-transitory, computer readable media that store instructions that when executed by the one or more processors cause the computing system to perform operations, the operations comprising:
obtaining data indicative of an object density from a plurality of autonomous light electric vehicles within a geographic area;
determining an aggregated object density for the geographic area based at least in part on the data indicative of the object density obtained from the plurality of autonomous light electric vehicles; and
controlling an operation of at least one autonomous light electric vehicle within the geographic area based at least in part on the aggregated object density for the geographic area.

14. The computing system of claim 13, wherein the operations further comprise:
obtaining, by the computing system, data indicative of a destination for a rider of the at least one autonomous light electric vehicle; and
wherein controlling the operation of the at least one autonomous light electric vehicle within the geographic area based at least in part on the aggregated object density for the geographic area comprises determining one or more navigational instructions for the rider to navigate to the destination based at least in part on the aggregated object density for the geographic area.

15. The computing system of claim 14, wherein the one or more navigational instructions are further determined based at least in part on a route score; and
wherein the route score is determined based at least in part on an availability of autonomous light electric vehicle infrastructure within the geographic area.

16. The computing system of claim 14, further comprising:
providing, by a user interface of the autonomous light electric vehicle, the one or more navigational instructions to the rider of the autonomous light electric vehicle.

17. The computing system of claim 14, further comprising:
providing, by the computing system to a user computing device associated with the rider, the one or more navigational instructions to the rider of the autonomous light electric vehicle.

18. The computing system of claim 13, wherein controlling the operation of the at least one autonomous light electric vehicle within the geographic area based at least in part on the aggregated object density for the geographic area comprises limiting an operation of the at least one autonomous vehicle within a subset of the geographic area based at least in part on the aggregated object density for the geographic area; and
wherein limiting the operation comprises one or more of: limiting a maximum speed of the at least one autonomous light electric vehicle within the subset of the geographic area, limiting an area of a travelway in which the at least one autonomous light electric vehicle can operate within the subset of the geographic area, and prohibiting the at least one autonomous light electric vehicle from operating within the subset of the geographic area.

19. The computing system of claim 13, wherein obtaining data indicative of an object density from the plurality of autonomous light electric vehicles within the geographic area comprises obtaining, from at least one autonomous light electric vehicle, data indicative of a number of objects detected by the at least one autonomous light electric vehicle and the location of the at least one autonomous light electric vehicle.

20. An autonomous light electric vehicle comprising:
a camera;
one or more pressure sensors, torque sensors, or force sensors;
one or more one or more processors; and
one or more tangible, non-transitory, computer readable media that store instructions that when executed by the one or more processors cause the computing system to perform operations, the operations comprising:
obtaining image data from the camera;
obtaining sensor data from the one or more pressure sensors, torque sensors, or force sensors;
determining that the autonomous light electric vehicle has a likelihood of interacting with an object based at least in part on the image data;
determining a weight distribution of a payload onboard the autonomous light electric vehicle based at least in part on the sensor data;
in response to determining that the autonomous light electric vehicle has the likelihood of interacting with an object, determining a deceleration rate or an acceleration rate for the autonomous light electric vehicle based at least in part the weight distribution of the payload; and
controlling the autonomous light electric vehicle according to the deceleration rate or the acceleration rate.
